(19) United States
(12) Patent Application Publication
(10) Pub. No.: US 2026/0012979 A1
(43) Pub. Date: Jan. 8, 2026

(54) DETERMINATION OF RANDOM ACCESS CHANNEL RESOURCE AND TRANSMISSION POWER FOR MULTIPLE PHYSICAL RANDOM ACCESS CHANNEL TRANSMISSIONS

(71) Applicant: Telefonaktiebolaget LM Ericsson (publ), Stockholm (SE)

(72) Inventors: Ling SU, Beijing, Hubei (CN); Jonas SEDIN, Brentford Greater London (GB); Yuande TAN, Beijing, Hubei (CN); Anqi HE, Beijing, Hubei (CN); Johan AXNÄS, Solna (SE); Robert Mark HARRISON, Grapevine, TX (US); Chunhui ZHANG, Stockholm (SE)

(21) Appl. No.: 18/881,176

(22) PCT Filed: Jun. 30, 2023
(86) PCT No.: PCT/IB2023/056875

§ 371 Date: Jan. 3, 2025

(30) Foreign Application Priority Data
Jul. 4, 2022 (WO) PCT/CN2022/103635

(51) Int. Cl. H04W 74/0833

(52) U.S. Cl. CPC H04W 74/0833

(57) ABSTRACT

During a random access (“RA”) procedure associated with a network node of a new radio (“NR”) communications network, a communication device can determine information associated with at least one of the communication device and a channel between the communication device and the network node. The communication device can further determine a number of physical RA channel (“PRACH”) transmissions to transmit to the network node prior to receiving a random access response as part of the RA procedure based on the information. The communication device can further transmit the number of PRACH transmissions to the network node as part of the RA procedure.

### TECHNICAL FIELD

The present disclosure is related to wireless communication systems and more particularly to determination of random access channel (“RACH”) resource and transmission power for multiple physical random access channel (“PRACH”) transmissions.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Random access channel (“RACH”) repetition was introduced in Rel-13 work items (“Wis”) of “Further LTE Physical Layer Enhancements for MTC” and “NarrowBand IoT (NB-IoT)” to extend coverage in Long Term Evolution (“LTE”), although RACH repetition is not presently supported in NR releases up to Rel-17.

Repetition of the information is a technique to achieve coverage enhancements. It can be used for all physical channels available for coverage enhanced UEs in LTE, for example, machine-type communication physical downlink control channel (“M-PDCCH”), physical broadcast channel (“PBCH”), physical downlink shared channel (“PDSCH”), physical uplink control channel (“PUCCH”), physical uplink shared channel (“PUSCH”), and physical random access channel (“PRACH”).

The UE can decide the repetition level for the initial PRACH transmission. The repetition levels that the cell supports (e.g., 5, 10, and 15 dB) can be included in the system information and the UE can select one of these based on, for example, the estimated channel quality.

During an initial random access the UE can measure the downlink (“DL”) quality. The UE can select a suitable repetition level for its initial PRACH preamble transmission among 4 levels. If the UE does not receive a random access response (“RAR”) it can increase its PRACH repetition level. A number of repetitions for RAR and following messages can depend on the level for the successful PRACH Coverage enhancement for the physical random access PRACH preamble can be

achieved partly through relaxation of the required PRACH misdetection probability and partly through repetition of the legacy LTE PRACH formats. A maximum of three different repetition levels (plus the zero coverage enhancement level) can be configured, where each level has its own configurable number of repetitions and attempts in order to adapt to the UE's coverage situation. For initial random access the UE choses its repetition level based on RSRP measurements. If the UE does not receive a RAR after the maximum number of attempts of its current level, it moves to the next higher one. No power ramping is used for large repetition levels; otherwise the current procedure is used. Different coverage levels correspond to different PRACH resources (e.g., different combinations of preamble sequences, timing, and narrowbands) and the available resources are signaled in a system information block (“SIB”).

The RAR message in LTE can be scheduled with M-PDCCH and an associated PDSCH. The UE can know the repetition level, possible start subframe, and frequency resource of the M-PDCCH from its most recent PRACH transmission (in combination with information signaled in SIB).

To enable different operation modes depending on a UE's need of coverage extension, two coverage enhancement modes have been introduced for RRC_CONNECTED LTE UEs: coverage extension (“CE”) mode A and CE mode B. CE mode A is for no or small coverage enhancement, requiring a few (e.g. up to a few tens of) repetitions. CE mode B is for a medium to large coverage enhancement, requiring several (e.g., hundreds of) repetitions. The CE mode can be signaled to the UE by the network.

### SUMMARY

According to some embodiments, a method of operating a communication device during a random access (“RA”) procedure associated with a network node of a new radio (“NR”) communications network is provided. The method includes determining information associated with at least one of the communication device and a channel between the communication device and the network node. The method further includes determining a number of physical RA channel (“PRACH”) transmissions to transmit to the network node prior to receiving a random access response as part of the RA procedure based on the information. The method further includes transmitting the number of PRACH transmissions to the network node as part of the RA procedure.

According to other embodiments, a method of operating a network node of a new radio (“NR”) communications network during a random access (“RA”) procedure associated with a communication device is provided. The method includes determining information associated with at least one of the communication device and a channel between the communication device and the network node. The method further includes determining a number of physical RA channel (“PRACH”) transmissions to receive from the communication device as part of the RA procedure based on the information. The method further includes monitoring the NR communications network for the number of PRACH transmissions from the communication device as part of the RA procedure.

According to other embodiments, a communication device, network node, non-transitory readable medium, computer program, or computer program product is provided to perform one of the above methods.

Certain embodiments may provide one or more of the following technical advantages. In some examples, determining a RACH resource and transmission power for multiple PRACH transmissions can reduce the time it takes for a UE to connect to a communications network and improve the resulting connection.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a table illustrating an example of frame structure type 2 random access configurations for preamble formats 0-4;

FIG. 3 is a table illustrating an example of frame structure type 2 random access preamble mapping in time and frequency;

FIG. 4 is a diagram illustrating an example of a PRACH-Config information element;

FIG. 5 is a diagram illustrating an example of a RACH-ConfigCommon information element;

FIG. 6 is a table illustrating an example of random access preamble parameters for frame structure type 2;

FIG. 7 is a table illustrating an example of random access configurations for FR1 and unpaired spectrum;

FIG. 8 is a table illustrating an example of random access configurations for FR2 and unpaired spectrum;

FIG. 9 is a table illustrating an example of a TPC command for PUSCH;

FIG. 10 is a table illustrating an example of mapping between PRACH configuration period and SS/PBCH block to PRACH occasion association period;

FIG. 11 is a diagram illustrating an example of a RACH-ConfigCommon IE;

FIG. 12 is a diagram illustrating an example of a BeamFailureRecoveryConfig;

FIGS. 13A-D are schematic diagrams illustrating examples of scenarios associated with multiple PRACH transmissions in accordance with some embodiments;

FIG. 14 is a graph illustrating an example of a preamble pattern in accordance with some embodiments;

FIG. 15 is a graph illustrating an example of Msg1 repetitions configured using RACH indication and partitioning framework in accordance with some embodiments;

FIGS. 16A-B are diagrams illustrating examples of PRACH occasions of two PRACH configuration indices in accordance with some embodiments;

FIGS. 17A-B are diagrams illustrating examples of RO with preambles for specific numbers of PRACH transmissions in accordance with some embodiments;

FIG. 18 is a flow chart illustrating an example of a network node coherently combining multiple PRACH transmissions

FIG. 19 is a flow chart illustrating an example of a network node non-coherently combining multiple PRACH transmissions

FIG. 20 is a diagram illustrating an example of a larger delay spread caused by transmissions with different Tx beams in accordance with some embodiments;

FIGS. 21A-B are diagrams illustrating examples of RO and SSB mapping in accordance with some embodiments;

FIG. 22 is a diagram illustrating an example of a preamble selection with multiple SSB mapping one RO in accordance with some embodiments;

FIG. 23 is a flow chart illustrating an example of operations performed by a communication device during a RA procedure in accordance with some embodiments;

FIG. 24 is a flow chart illustrating an example of operations performed by a network node during a RA procedure in accordance with some embodiments;

FIG. 25 is a block diagram of a communication system in accordance with some embodiments;

FIG. 26 is a block diagram of a user equipment in accordance with some embodiments;

FIG. 27 is a block diagram of a network node in accordance with some embodiments;

FIG. 28 is a block diagram of a host computer communicating with a user equipment in accordance with some embodiments;

FIG. 29 is a block diagram of a virtualization environment in accordance with some embodiments; and

FIG. 30 is a block diagram of a host computer communicating via a base station with a user equipment over a partially wireless connection in accordance with some embodiments in accordance with some embodiments.

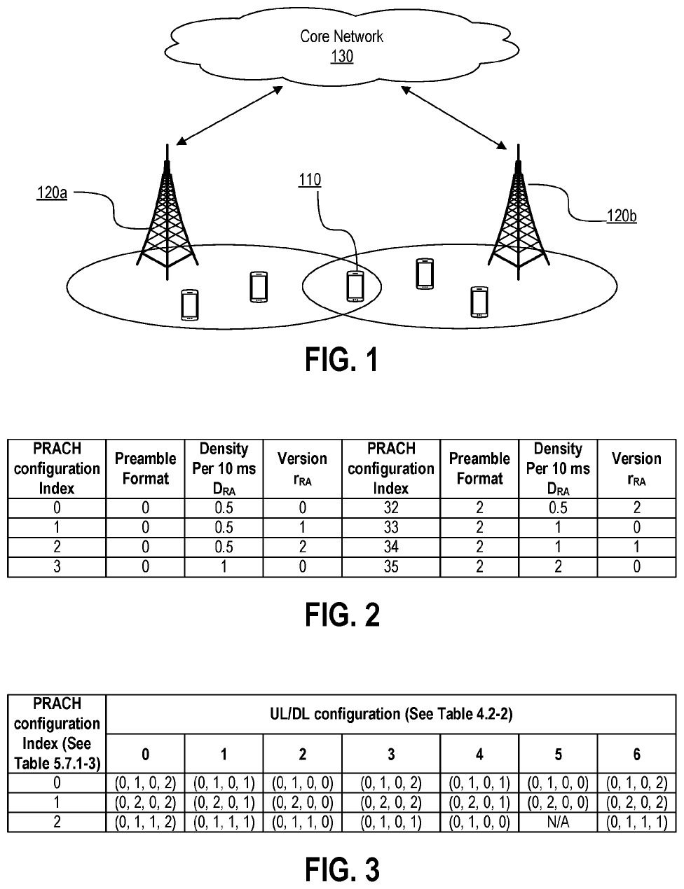

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Considering random access operations for the Long Term Evolution (“LTE”) standard, as mentioned above, the user equipment (“UE”) can move from no or small coverage enhancements (coverage extension (“CE”) mode A) to large coverage enhancements (CE mode B) when signaled. The idea is to only keep a UE in CE mode B if it is not able to do synchronization acquisition, system information acquisition, random access or data transmission using small coverage operation. In enhanced coverage operation, the number of repetitions can be adapted according to the UE's coverage situation.

In some examples, a UE is a bandwidth reduced/low complexity (“BL”) UE or a UE in enhanced coverage. If the random access preamble was transmitted in a non-terrestrial network, a random access response (“RAR”) window starts at the subframe that contains the end of the last preamble repetition plus 3+UE-eNB round trip time (“RTT”) subframes and has length ra-Response WindowSize for the corresponding enhanced coverage level. Otherwise, the RAR window starts at the subframe that contains the end of the last preamble repetition plus three subframes and has length ra-ResponseWindowSize for the corresponding enhanced coverage level.

In additional or alternative examples, a UE is a narrowband internet-of-things (“NB-IoT”) UE. If the random access preamble was transmitted in a non-terrestrial network, the RAR window starts at the subframe that contains the end of the last preamble repetition plus X+UE-eNB RTT subframes and has length ra-Response WindowSize for the corresponding enhanced coverage level, where value X is determined based on the used preamble format and the number of NPRACH repetitions. Otherwise, the random access response (“RAR”) window starts at the subframe that contains the end of the last preamble repetition plus X subframes and has length ra-ResponseWindowSize for the corresponding enhanced coverage level, where value X is determined based on the used preamble format and the number of NPRACH repetitions. The RA-radio network temporary identifier (“RNTI”) associated with the physical

random access channel (“PRACH”) in which the Random Access Preamble is transmitted, is computed as:

$$RA - RNTI = 1 + t\_id + 10 * f\_id$$

where t_id is the index of the first subframe of the specified PRACH (0≤t_id<10), and f_id is the index of the specified PRACH within that subframe, in ascending order of frequency domain (0≤f_id<6) except for narrowband internet-of-thins (“NB-IoT”) UEs, bandwidth reduced/low capacity (“BL”) UEs or UEs in enhanced coverage. If the PRACH resource is on a time division duplex (“TDD”) carrier, the f_id is set to f_{RA}.

For BL UEs and UEs in enhanced coverage, RA-RNTI associated with the PRACH in which the Random Access Preamble is transmitted, is computed as:

$$RA - RNTI = 1 + t\_id + 10 * f\_id + 60 * ( SFN\_id mod ( W max / 10 ) )$$

where t_id is the index of the first subframe of the specified PRACH (0≤t_id<10), f_id is the index of the specified PRACH within that subframe, in ascending order of frequency domain (0≤f_id<6), SFN_id is the index of the first radio frame of the specified PRACH, and Wmax is 400, maximum possible RAR window size in subframes for BL UEs or UEs in enhanced coverage. If the PRACH resource is on a TDD carrier, the f_id is set to f_{RA}.

For NB-IoT UEs, the RA-RNTI associated with the PRACH in which the Random Access Preamble is transmitted, is computed as:

$$RA - RNTI = 1 + floor ( SFN\_id / 4 ) + 256 * carrier\_id$$

where SFN_id is the index of the first radio frame of the specified PRACH and carrier_id is the index of the uplink (“UL”) carrier associated with the specified PRACH. The carrier_id of the anchor carrier is 0.

For BL/CE UEs, for each PRACH coverage enhancement level, there is a PRACH configuration configured by higher layers with a PRACH configuration index (prach-ConfigurationIndex), a PRACH frequency offset

$${\overline{n}}_{PRBoffset}^{R A}$$

(prach-FrequencyOffset), a number of PRACH repetitions per attempt

$${N}_{r e p}^{P R A C H}$$

(numRepetitionPerPreambleAttempt) and optionally a PRACH starting subframe periodicity

$${N}_{start}^{P R A C H}$$

(prach-StartingSubframe). PRACH of preamble format 0-3 is transmitted

$${N}_{r e p}^{P R A C H} \geq 1$$

times, whereas PRACH or preamble format 4 is transmitted one time only.

For BL/CE UEs and for each PRACH coverage enhancement level, if frequency hopping is enabled for a PRACH configuration by the higher-layer parameter prach-HoppingConfig, the value of the parameter

$${n}_{PRB offset}^{R A}$$

depends on the system frame number (“SFN”) and the PRACH configuration index.

In case the PRACH configuration index is such that a PRACH resource occurs in every radio frame when calculated as below from the table in FIG. 2,

$${n}_{PRB offset}^{R A} = \{ \begin{matrix}{\overline{n}}_{PRB offset}^{R A} & if {n}_{f} mod 2 = 0 \\ ( {\overline{n}}_{PRB offset}^{R A} + {f}_{PRB , hop}^{PRACH} ) mod {N}_{RB}^{UL} & if {n}_{f} mod 2 = 1\end{matrix}$$

$$otherwise$$

$${n}_{PRB offset}^{R A} = \{ \begin{matrix}{\overline{n}}_{PRB offset}^{R A} & if ⌊ \frac{{n}_{f} mod 4}{2} ⌋ = 0 \\ ( {\overline{n}}_{PRB offset}^{R A} + {f}_{PRB , hop}^{PRACH} ) mod {N}_{RB}^{UL} & if ⌊ \frac{{n}_{f} mod 4}{2} ⌋ = 1\end{matrix}$$

where n_{f} is the system frame number corresponding to the first subframe for each PRACH repetition,

$${f}_{PRBhop}^{PRACH}$$

corresponds to a cell-specific higher-layer parameter prach-HoppingOffset. If frequency hopping is not enabled for the PRACH configuration then

$${n}_{PRB offset}^{R A} = {\overline{n}}_{PRB offset}^{R A} .$$

For frame structure type 1 with preamble format 0-3, for each of the PRACH configurations there is at most one random access resource per subframe.

For frame structure type 2 with preamble formats 0-4, for each of the PRACH configurations there might be multiple random access resources in an UL subframe (or UpPTS for preamble format 4) depending on the UL/DL configuration.

FIG. 2 illustrates an example of a table that lists PRACH configurations allowed for frame structure type 2 where the configuration index corresponds to a certain combination of preamble format, PRACH density value, D_{RA} and version index, r_{RA}.

For frame structure type 2 with PRACH configuration indices 0, 1, 2, 20, 21, 22, 30, 31, 32, 40, 41, 42, 48, 49, 50, or with PRACH configuration indices 51, 53, 54, 55, 56, 57 in UL/DL configuration 3, 4, 5, the UE may for handover purposes assume an absolute value of the relative time difference between radio frame i in the current cell and the target cell is less than 153600. Ts.

FIG. 2 lists the mapping to physical resources for the different random access opportunities needed for a certain PRACH density value, D_{RA}. Each quadruple of the format

$$( {f}_{R A} , {t}_{R A}^{( 0 )} , {t}_{R A}^{( 1 )} , {t}_{R A}^{( 2 )} )$$

frequency resource index within the considered time instance,

$${t}_{R A}^{( 0 )} = 0 , 1 , 2$$

indicates whether the resource is reoccurring in all radio frames, in even radio frames, or in odd radio frames, respectively,

$${t}_{R A}^{( 1 )} = 0 , 1$$

indicates whether the random access resource is located in first half frame or in second half frame, respectively, and where, t_{RA}⁽²⁾ is the uplink subframe number where the preamble starts, counting from 0 at the first uplink subframe between 2 consecutive downlink-to-uplink switch points, with the exception of preamble format 4 where

$${t}_{RA}^{( 2 )}$$

is denoted as (*). The start of the random access preamble formats 0-3 shall be aligned with the start of the corresponding uplink subframe at the UE assuming N_{TA}=0 and the random access preamble format 4 shall start 4832·Tₛ before the end of the UpPTS at the UE, where the UpPTS is referenced to the UE's uplink frame timing assuming N_{TA}=0.

The random access opportunities for each PRACH configuration shall be allocated in time first and then in frequency if and only if time multiplexing is not sufficient to hold all opportunities of a PRACH configuration needed for a certain density value D_{RA} without overlap in time. For preamble format 0-3, the frequency multiplexing shall be done according to

$${n}_{P R B}^{R A} = \{ \begin{matrix}{n}_{PRB offset}^{R A} + 6 ⌊ \frac{{f}_{RA}}{2} ⌋ , & if {f}_{RA} mod 2 = 0 \\ {N}_{RB}^{UL} - 6 - {n}_{PRB offset}^{RA} - 6 ⌊ \frac{{f}_{RA}}{2} ⌋ , & otherwise\end{matrix}$$

where

$${N}_{R B}^{UL}$$

is the number of uplink resource blocks,

$${n}_{PRB}^{R A}$$

is the first physical resource block allocated to the PRACH opportunity considered and where

$${n}_{PRB offset}^{RA}$$

is the first physical resource block available for PRACH.

For BL/CE UEs, only a subset of the subframes allowed for preamble transmission are allowed as starting subframes for the

$${N}_{rep}^{P R A C H}$$

repetitions. The allowed starting subframes for a PRACH configuration are determined as follows.

Enumerate the subframes that are allowed for preamble transmission for the PRACH configuration as

$${n}_{sf}^{R A} = 0 , … {N}_{sf}^{R A} - 1$$

where

$${n}_{sf}^{R A} = 0 and {n}_{sf}^{R A} = {N}_{sf}^{R A} - 1$$

correspond to the two subframes allowed for preamble transmission with the smallest and the largest absolute subframe number

$${n}_{s f}^{a b s} ,$$

respectively.

If a PRACH starting subframe periodicity

$${N}_{start}^{P R A C H}$$

is not provided by higher layers, the periodicity of the allowed starting subframes in terms of subframes allowed for preamble transmission is

$${N}_{rep}^{P R A C H} .$$

The allowed starting subframes defined over

$${n}_{sf}^{R A} = 0 , … {N}_{sf}^{R A} - 1$$

are given by

$${jN}_{rep}^{PRACH}$$

where J=0, 1, 2, . . . .

If a PRACH starting subframe periodicity

$${N}_{start}^{PRACH}$$

is provided by higher layers, it indicates the periodicity of the allowed starting subframes in terms of subframes allowed for preamble transmission. The allowed starting subframes defined over

$${n}_{sf}^{RA} = 0 , … {N}_{sf}^{RA} - 1$$

are given by

$${jN}_{start}^{PRACH} + {N}_{rep}^{PRACH}$$

where j=0, 1, 2, . . . .

No starting subframe defined over

$${n}_{sf}^{RA} = 0 , … {N}_{sf}^{RA} - 1$$

such that

$${n}_{sf}^{RA} > {N}_{sf}^{RA} - {N}_{rep}^{PRACH}$$

is allowed.

Each random access preamble occupies a bandwidth corresponding to 6 consecutive resource blocks for both frame structures.

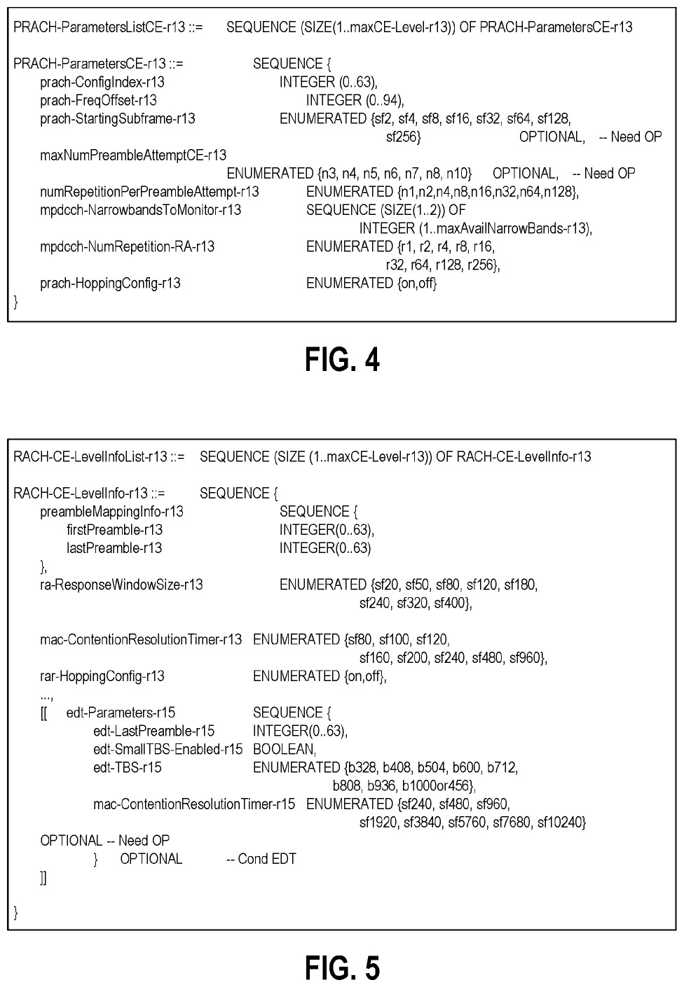

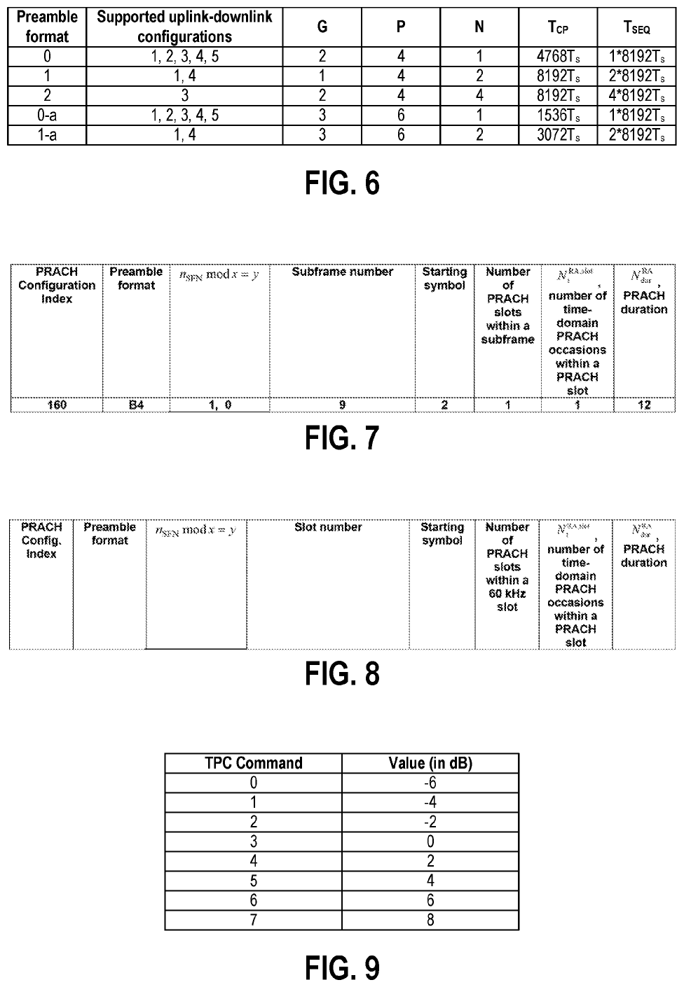

FIG. 3 illustrates an example of frame structure type 2 random access preamble mapping in time and frequency FIG. 4 illustrates an example of a PRACH-Config information element and FIG. 5 illustrates an example of a RACH-ConfigCommon information element. The physical layer random access preamble is based on single-subcarrier frequency-hopping symbol groups. A symbol group is illustrated in a table in FIG. 6, consisting of a cyclic prefix of length T_{CP} and a sequence of N identical symbols with total length T_{SEQ}. The total number of symbol groups in a preamble repetition unit is denoted by P. The number of time-contiguous symbol groups is given by G.

The preamble consisting of P symbol groups shall be transmitted

$${N}_{rep}^{NPRACH}$$

times. For frame structure type 2, when an invalid uplink subframe overlaps the transmission of G symbol groups without a gap, the G symbol groups are dropped. For frame structure type 2, the transmission of G symbol groups are aligned with the subframe boundary.

The frequency location of the NPRACH transmission is constrained within

$${N}_{sc}^{RA} = 12$$

sub-carriers, and within

$${N}_{sc}^{RA} = 36$$

subcarriers when preamble format 2 as described in FIG. 6 is configured. Frequency hopping shall be used within the 12 subcarriers and 36 subcarriers when preamble format 2 as described in FIG. 6 is configured, where the frequency location of the i^{th} symbol group is given by

$${n}_{sc}^{RA} ( i ) = {n}_{start} + {\tilde{n}}_{SC}^{RA} ( i )$$

where

$${n}_{start} = {N}_{scoffset}^{NPRACH} + ⌊ {n}_{init} / {N}_{s c}^{RA} ⌋ \cdot {N}_{sc}^{RA} .$$

The quantity

$${\tilde{n}}_{sc}^{RA} ( i )$$

depends on the frame structure.

Referring now to random access operation for the 3^{rd} Generation Partnship Project (“3GPP”) new radio (“NR”) standard, there are 64 preambles defined in each time-frequency PRACH occasion, enumerated in increasing order of first increasing cyclic shift C, of a logical root sequence, and then in increasing order of the logical root sequence index, starting with the index obtained from the higher-layer parameter prach-RootSequenceIndex or rootSequenceIndex-BFR. Additional preamble sequences, in case 64 preambles cannot be generated from a single root Zadoff-Chu sequence, are obtained from the root sequences with the consecutive logical indexes until all the 64 sequences are found. The logical root sequence order is cyclic; the logical index 0 is consecutive to 837 when L_{RA}=839 and is consecutive to 137 when L_{RA}=139. The sequence number u is obtained from the logical root sequence index.

The cyclic shift Cᵥ is given by

$${C}_{v} = \{ \begin{matrix}{vN}_{CS} & v = 0 , 1 , … , ⌊ {L}_{RA} / {N}_{CS} ⌋ - 1 , {N}_{CS} \neq 0 & for unrestricted sets \\ 0 & {N}_{CS} = 0 & for unrestricted sets \\ {d}_{start} ⌊ v / {n}_{shift}^{RA} ⌋ + ( v mod {n}_{shift}^{RA} ) {N}_{CS} & v = 0 , 1 , … , w - 1 & for restricted sets type A and B \\ {{d}^{\overline{\_}}}_{start} + ( v - w ) {N}_{CS} & v = w , … , w + {{n}^{\overline{\_}}}_{shift}^{RA} - 1 & for restricted sets type B \\ {\overline{d}}_{start} + ( v - w - {{n}^{\overline{\_}}}_{shift}^{RA} ) {N}_{CS} & v = w + {{n}^{\overline{\_}}}_{shift}^{RA} , … , w + {{n}^{\overline{\_}}}_{shift}^{RA} + {\overline{n}}_{shift}^{RA} - 1 & for restricted sets type B\end{matrix}$$

$$w = {n}_{shift}^{RA} {n}_{group}^{RA} + {\overline{n}}_{shift}^{RA}$$

where the higher-layer parameter restrictedSetConfig determines the type of restricted sets (unrestricted, restricted type A, restricted type B).

Parameters for determining the root sequence and their cyclic shifts in the PRACH preamble sequence set include: sequence length; a logic index to the root sequence table; and a preamble subcarrier spacing (“SCS”) (e.g., if SCS=1.25/5 kH then unrestricted, restricted set A, or restricted set B).

Random access preambles can only be transmitted in the time resources given by the higher-layer parameter prach-ConfigurationIndex according to the tables in FIGS. 7-8 and depends on FR1 or FR2 and a spectrum type.

Random access preambles can only be transmitted in the frequency resources given by the higher-layer parameter msg1-FrequencyStart. The PRACH frequency resources n_{RA}∈{0, 1, . . . , M−1}, where M equals the higher-layer parameter msg1-FDM, are numbered in increasing order within the initial uplink bandwidth part during initial access, starting from the lowest frequency. Otherwise, n_{RA} are numbered in increasing order within the active uplink bandwidth part, starting from the lowest frequency.

For the purpose of slot numbering, the following subcarrier spacing can be assumed: 15 kHz for FR1 and 60 kHz for FR2.

A number of time domain RACH occasions within a RACH slot for each PRACH configuration index is fixed.

For unpaired spectrum, if a UE is not provided tdd-UL-DL-ConfigurationCommon, a PRACH occasion in a PRACH slot is valid if it does not precede a synchronization signal (“SS”)/physical broadcast channel (“PBCH”) block in the PRACH slot and starts at least N_{gap} symbols after a last SS/PBCH block reception symbol, where N_{gap} is provided and, if channelAccessMode=“semiStatic” is provided, does not overlap with a set of consecutive symbols before the start of a next channel occupancy time where the UE does not transmit, the candidate SS/PBCH block index of the SS/PBCH block corresponds to the SS/PBCH block index provided by ssb-PositionsInBurst in SIB1 or in ServingCellConfigCommon.

If a UE is provided tdd-UL-DL-ConfigurationCommon, a PRACH occasion in a PRACH slot is valid if it is within UL symbols or it does not precede a SS/PBCH block in the PRACH slot and starts at least N_{gap} symbols after a last downlink symbol and at least N_{gap} symbols after a last SS/PBCH block symbol, where N_{gap} is provided and if channelAccessMode=“semiStatic” is provided, does not overlap with a set of consecutive symbols before the start of a next channel occupancy time where there shall not be any transmissions. The candidate SS/PBCH block index of the SS/PBCH block corresponds to the SS/PBCH block index provided by ssb-PositionsInBurst in system information block 1 (“SIB1”) or in ServingCellConfigCommon.

For preamble format B4, N_{gap}=0.

For operation on a single carrier in unpaired spectrum, if a UE is configured by higher layers to transmit sounding reference signal (“SRS”), physical uplink control channel (“PUCCH”), physical uplink shared channel (“PUSCH”), or PRACH in a set of symbols of a slot and the UE detects a downlink control information (“DCI”) format indicating to the UE to receive channel state information reference signal (“CSI-RS”) or physical downlink shared channel (“PDSCH”) in a subset of symbols from the set of symbols, then if the UE does not indicate the capability of [partialCancellation], the UE does not expect to cancel the transmission of the PUCCH or PUSCH or PRACH in the set of symbols if the first symbol in the set occurs within T_{proc,2} relative to a last symbol of a control resource set (“CORESET”) where the UE detects the DCI format; otherwise, the UE cancels the PUCCH, or the PUSCH, or an actual repetition of the PUSCH determined from the PRACH transmission in the set of symbols. If the UE indicates the capability of [partialCancellation], the UE does not expect to cancel the transmission of the PUCCH or PUSCH or PRACH in symbols from the set of symbols that occur within T_{proc,2} relative to a last symbol of a CORESET where the UE detects the DCI format. The UE cancels the PUCCH, or the PUSCH, or an actual repetition of the PUSCH [6, TS 38.214], determined from the PRACH transmission in remaining symbols from the set of symbols.

A PRACH is transmitted using the selected PRACH format with transmission power P_{PRACH,b,f,c}(i) on the indicated PRACH resource, with BWP b of carrier f of serving cell c.

$${P}_{PRACH , b , f , c} ( i ) = min \{ {P}_{CMAX , f , c} ( i ) , {P}_{PRACH , target , b , f , c} ( i ) + P {L}_{b , f , c} \} [ dBm ]$$

If within a random access response window, the UE does not receive a random access response that contains a preamble identifier corresponding to the preamble sequence transmitted by the UE, the UE determines a transmission power for a subsequent PRACH transmission, if any.

If prior to a PRACH retransmission, a UE changes the spatial domain transmission filter, Layer 1 notifies higher layers to suspend the power ramping counter.

The MAC entity shall, for each Random Access Preamble:
1> if PREAMBLE_TRANSMISSION_COUNTER is greater than one; and
1> if the notification of suspending power ramping counter has not been received from lower layers; and
1> if SSB or CSI-RS selected is not changed from the selection in the last Random Access Preamble transmission:
   2> increment PREAMBLE_POWER_RAMPING_COUNTER by 1.
1> select the value of DELTA_PREAMBLE;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX and PREAMBLE_RECEIVED_TARGET_POWER.

Support for Msg3 repetition was introduced in Rel-17 NR. A UE can be configured by parameters given in an SIB to repeat Msg3. Unlike LTE, the UE can request repetitions for PUSCH transmission, and does so by transmitting a RACH preamble associated with the repetition procedure. The network then indicates the number of repetitions

$${N}_{PUSCH}^{repeat}$$

via an MCS field in either RAR or in a PDCCH carrying DCI format 0_0.

A UE can be provided in RACH-ConfigCommon a set of numbers of repetitions for a PUSCH transmission with PUSCH repetition Type A that is scheduled by a RAR UL grant or by a DCI format 0_0 with CRC scrambled by a temporary cell radio network temporary identifier (“TC-RNTI”). If the UE requests repetitions for the PUSCH transmission, the UE transmits the PUSCH over

$${N}_{PUSCH}^{repeat}$$

slots, where

$${N}_{PUSCH}^{repeat}$$

is indicated by the 2 MSBs of the MCS field in the RAR UL grant or in the DCI format 0_0 from a set of four values provided by numberOfMsg3Repetitions or from {1, 2, 3, 4} if numberOfMsg3Repetitions is not provided. The UE determines an MCS for the PUSCH transmission by the 2 LSBs of the MCS field in the RAR UL grant or by the 3 LSBs of the MCS field in the DCI format 0_0, and determines a redundancy version and RBs for each repetition as described in [6, TS 38.214]. For unpaired spectrum operation, the UE determines the

$${N}_{PUSCH}^{repeat}$$

slots as the first

$${N}_{PUSCH}^{repeat}$$

slots starting from slot n+k₂+Δ where a repetition of the PUSCH transmission does not include a symbol indicated as downlink by tdd-UL-DL-ConfigurationCommon or indicated as a symbol of an SS/PBCH block with index provided by ssb-PositionsInBurst.

If a UE transmits a PUSCH on active UL BWP b of carrier f of serving cell C using parameter set configuration with index j and PUSCH power control adjustment state with index 1, the UE determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

[dBm]
where, for the PUSCH power control adjustment state f_{b,f,c}(i,l) for active UL BWP b of carrier f of serving cell C in PUSCH transmission occasion i, if the UE receives a random access response message in response to a PRACH transmission on active UL BWP b of carrier f of serving cell C f_{b,f,c}(0,l)=ΔP_{rampup,b,f,c}+g, δ_{msg 2,b,f,c}, where l=0 and δ_{msg 2,b,f,c} is a TPC command value indicated in the random access response grant of the random access response message corresponding to the PRACH transmission on active UL BWP b of carrier f in the serving cell

$$, and Δ {P}_{rampup , g , f , c} = min [ \{ max ( 0 , {P}_{CMAX , f , c} - ( \begin{matrix}10 {log}_{10} ( {2}^{μ} \cdot {M}_{RB , b , f , c}^{PUSCH} ( 0 ) ) + \\ {P}_{O \_ PUSCH , b , f , c} ( 0 ) + {α}_{b , f , c} ( 0 ) \cdot {PL}_{c} \\ {Δ}_{TF , b , f , c} ( 0 ) + {δ}_{msg 2 , b , f , c}\end{matrix} ) ) \} , Δ {P}_{rampup , g , f , c} ]$$

and ΔP_{rampuprequested,b,f,c} is provided by higher layers and corresponds to the total power ramp-up requested by higher layers from the first to the last random access preamble for carrier f in the serving cell C,

$${M}_{RB , b , f , c}^{PUSCH} ( 0 )$$

is the bandwidth of the PUSCH resource assignment expressed in number of resource blocks for the first PUSCH transmission on active UL BWP b of carrier f of serving cell C, and Δ_{TF,b,f,c}(0) is the power adjustment of first PUSCH transmission on active UL BWP b of carrier f of serving cell C.

The TPC command value δ_{msg2,b,f,c} is used for setting the power of the PUSCH transmission is interpreted according to FIG. 9

In some examples, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

If N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index

$$n \cdot {N}_{total}^{preamble} / N$$

where

$${N}_{total}^{preamble}$$

is provided by totalNumberOfRA-Preambles for Type-1 random access procedure.

SS/PBCH block indexes provided by ssb-PositionsInBurst in SIB1 or in ServingCellConfigCommon are mapped to valid PRACH occasions in the following order where the parameters are described. First, in increasing order of preamble indexes within a single PRACH occasion. Second, in increasing order of frequency resource indexes for frequency multiplexed PRACH occasions. Third, in increasing order of time resource indexes for time multiplexed PRACH occasions within a PRACH slot. Fourth, in increasing order of indexes for PRACH slots

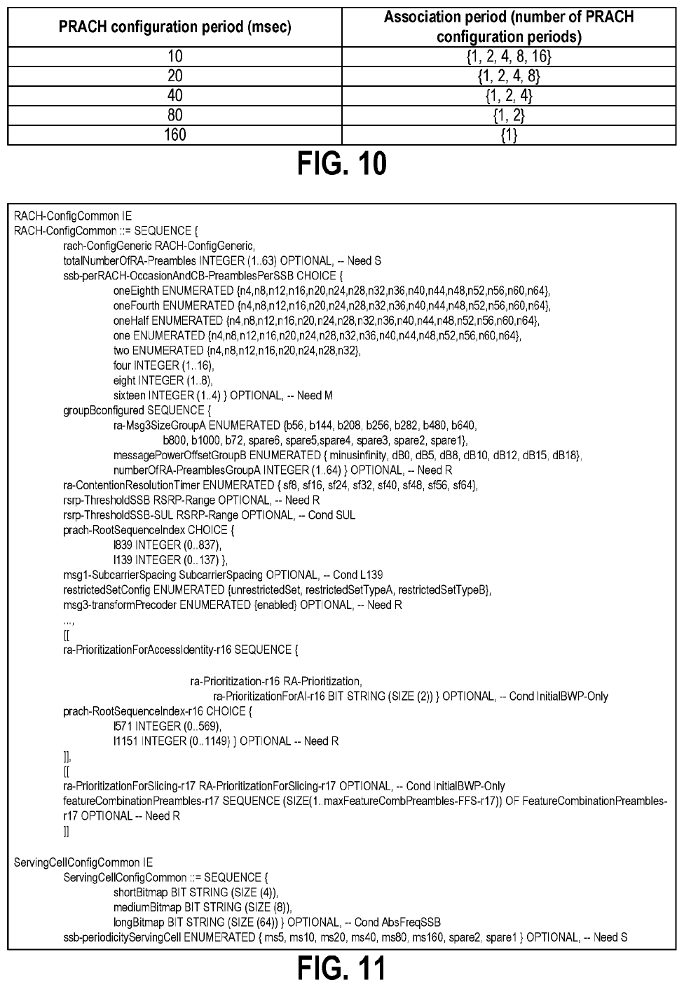

In some examples, an association period, starting from frame 0, for mapping SS/PBCH blocks to PRACH occasions is the smallest value in the set determined by the PRACH configuration period according to FIG. 10 such that N_{Tx}^{SSB} SS/PBCH blocks are mapped at least once to the PRACH occasions within the association period, where a UE obtains N_{Tx}^{SSB} from the value of ssb-PositionsInBurst in SIB1 or in ServingCellConfigCommon. If after an integer number of SS/PBCH blocks to PRACH occasions mapping cycles within the association period there is a set of PRACH occasions or PRACH preambles that are not mapped to N_{Tx}^{SSB} SS/PBCH blocks, no SS/PBCH blocks are mapped to the set of PRACH occasions or PRACH preambles. An association pattern period includes one or more association periods and is determined so that a pattern between PRACH occasions and SS/PBCH blocks repeats at most every 160 msec. PRACH occasions not associated with SS/PBCH blocks after an integer number of association periods, if any, are not used for PRACH transmissions.

In some examples, the PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For the indicated preamble index, the ordering of the PRACH occasions is: 1) in increasing order of frequency resource indexes for frequency multiplexed PRACH occasions; 2) in increasing order of time resource indexes for time multiplexed PRACH occasions within a PRACH slot; and 3) in increasing order of indexes for PRACH slots. FIG. 11 illustrates an example of a RACH-ConfigCommon information element (“IE”).

In response to a PRACH transmission, a UE attempts to detect a DCI format 1_0 with CRC scrambled by a corresponding RA-RNTI during a window controlled by higher layers. The window starts at the first symbol of the earliest CORESET the UE is configured to receive PDCCH for Type1-PDCCH CSS set, as defined in Clause 10.1, that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by ra-ResponseWindow.

The TPC command value δ_{msg 2,b,f,c} is used for setting the power of the PUSCH transmission is interpreted according to FIG. 9. The CSI request field is reserved.

In some example, if the UE receives a random access response message in response to a PRACH transmission on active UL BWP b of carrier f of serving cell C, f_{b,f,c}(0,l)=ΔP_{rampup,b,f,c}+δ_{msg 2,b,f,c}, where l=0 and δ_{msg 2,b,f,c} is a TPC command value indicated in the random access response grant of the random access response message corresponding to the PRACH transmission on active UL BWP b of carrier f in the serving cell C.

Radio resource control (“RRC”) can configure the following parameters for a RA procedure. [0098]prach-ConfigurationIndex: the available set of PRACH occasions for the transmission of the Random Access Preamble.

preambleReceivedTargetPower: initial Random Access Preamble power.

rsrp-ThresholdSSB: an RSRP threshold for the selection of the SSB. If the Random Access procedure is initiated for beam failure recovery, rsrp-ThresholdSSB used for the selection of the SSB within candidateBeamRSList refers to rsrp-ThresholdSSB in BeamFailureRecoveryConfig IE.

rsrp-ThresholdCSI-RS: an RSRP threshold for the selection of CSI-RS. If the Random Access procedure is initiated for beam failure recovery, rsrp-ThresholdCSI-RS is equal to rsrp-ThresholdSSB in BeamFailureRecoveryConfig IE.

rsrp-ThresholdSSB-SUL: an RSRP threshold for the selection between the NUL carrier and the SUL carrier.

candidateBeamRSList: a list of reference signals (CSI-RS and/or SSB) identifying the candidate beams for recovery and the associated Random Access parameters.

recoverySearchSpaceId: the search space identity for monitoring the response of the beam failure recovery request.

powerRampingStep: the power-ramping factor.

powerRampingStepHighPriority: the power-ramping factor in case of prioritized Random Access procedure.

scalingFactorBL: a scaling factor for prioritized Random Access procedure.

ra-PreambleIndex: Random Access Preamble.

ra-ssb-OccasionMaskIndex: defines PRACH occasion(s) associated with an SSB in which the MAC entity may transmit a Random Access Preamble.

ra-OccasionList: defines PRACH occasion(s) associated with a CSI-RS in which the MAC entity may transmit a Random Access Preamble.

ra-PreambleStartIndex: the starting index of Random Access Preamble(s) for on-demand SI request.

preambleTransMax: the maximum number of Random Access Preamble transmission.

ssb-perRACH-OccasionAndCB-PreamblesPerSSB: defines the number of SSBs mapped to each PRACH occasion and the number of contention-based Random Access Preambles mapped to each SSB.

If groupBconfigured is configured, then Random Access Preambles group B is configured. Amongst the contention-based Random Access Preambles associated with an SSB, the first numberOfRA-PreamblesGroupA Random Access Preambles belong to Random Access Preambles group A. The remaining Random Access Preambles associated with the SSB belong to Random Access Preambles group B (if configured). If Random Access Preambles group B is supported by the cell Random Access Preambles group B is included for each SSB.

Beam failure detection and recovery is described below.

In some examples, for beam failure detection, the gNB configures the UE with beam failure detection reference signals (SSB or channel state information reference signal (“CSI-RS”)) and the UE declares beam failure when the number of beam failure instance indications from the physical layer reaches a configured threshold before a configured timer expires.

In additional or alternative examples, SSB-based Beam Failure Detection is based on the SSB associated to the initial DL bandwidth part (“BWP”) and can only be configured for the initial DL BWPs and for DL BWPs containing the SSB associated to the initial DL BWP. For other DL BWPs, Beam Failure Detection can only be performed based on CSI-RS.

After beam failure is detected, the UE triggers beam failure recovery by initiating a Random Access procedure on the PCell and selects a suitable beam to perform beam failure recovery (if the gNB has provided dedicated Random Access resources for certain beams, those will be prioritized by the UE).

Upon completion of the Random Access procedure, beam failure recovery is considered complete.

In some examples, the media access control (“MAC”) entity shall:
1> if beam failure instance indication has been received from lower layers:
   2> start or restart the beamFailureDetectionTimer;
   2> increment BFI_COUNTER by 1;
   2> if BFI_COUNTER>=beamFailureInstanceMaxCount:
      3> initiate a Random Access procedure on the SpCell.
1> if the beamFailureDetectionTimer expires; or
1> if beamFailureDetectionTimer, beamFailureInstanceMaxCount, or any of the reference signals used for beam failure detection is reconfigured by upper layers:
   2> set BFI_COUNTER to 0.
1> if the Random Access procedure is successfully completed (:
   2> set BFI_COUNTER to 0;
   2> stop the beamFailureRecoveryTimer, if configured;
   2> consider the Beam Failure Recovery procedure successfully completed.

A UE can be provided, for each BWP of a serving cell, a set q̅₀ of periodic CSI-RS resource configuration indexes by failureDetectionResources and a set q̅₁ of periodic CSI-RS resource configuration indexes and/or SS/PBCH block indexes by candidateBeamRSList for radio link quality measurements on the BWP of the serving cell. If the UE is not provided failureDetectionResources, the UE determines the set q̅₀ to include periodic CSI-RS resource configuration indexes with same values as the RS indexes in the RS sets indicated by TCI-State for respective CORESETs that the UE uses for monitoring PDCCH and, if there are two RS indexes in a TCI state, the set q̅₀ includes RS indexes with QCL-TypeD configuration for the corresponding TCI states. The UE expects the set q̅₀ to include up to two RS indexes. The UE expects single port RS in the set q̅₀.

In non-DRX mode operation, the physical layer in the UE provides an indication to higher layers when the radio link quality for all corresponding resource configurations in the set q̅₀ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations and/or SS/PBCH blocks in the set q̅₀ that the UE uses to assess the radio link quality and 2 msec. In DRX mode operation, the physical layer provides an indication to higher layers when the radio link quality is worse than the threshold Q_{out,LR} with a periodicity.

Upon request from higher layers, the UE provides to higher layers the periodic CSI-RS configuration indexes and/or SS/PBCH block indexes from the set q̅₁ and the corresponding L1-RSRP measurements that are larger than or equal to the Q_{in,LR} threshold.

The UE may receive by PRACH-ResourceDedicatedBFR, a configuration for PRACH transmission. For PRACH transmission in slot n and according to antenna port quasi co-location parameters associated with periodic CSI-RS resource configuration or with SS/PBCH block associated with index q_{new} provided by higher layers, the UE monitors PDCCH in a search space set provided by recoverySearchSpaceId for detection of a DCI format with CRC scrambled by C-RNTI or MCS-C-RNTI starting from slot n+4 within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

After 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo or is provided PUCCH-SpatialRelationInfo for PUCCH resource(s), the UE transmits a PUCCH on a same cell as the PRACH transmission using a same spatial filter as for the last PRACH transmission and a power determined with qᵤ=0, q_{d}=q_{new}, and l=0

After 28 symbols from a last symbol of a first PDCCH reception in a search space set provided by recoverySearchSpaceId where a UE detects a DCI format with CRC scrambled by C-RNTI or MCS-C-RNTI, the UE assumes same antenna port quasi-collocation parameters as the ones associated with index q_{new} for PDCCH monitoring in a CORESET with index 0.

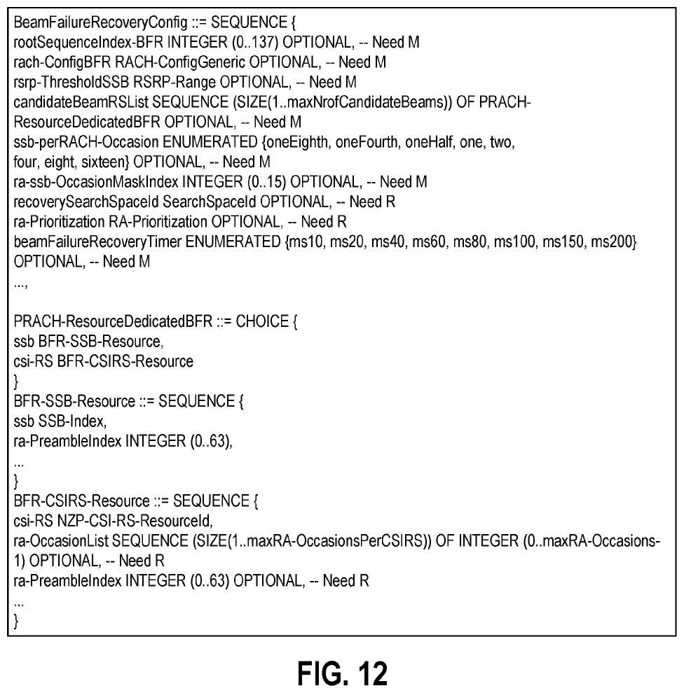

FIG. 12 illustrates an example of a BeamFailureRecoveryConfig. The list of reference signals (CSI-RS and/or SSB) identifying the candidate beams for recovery and the associated RA parameters. The UE shall consider this list to include all elements of candidateBeamRSList (without suffix) and all elements of candidateBeamRSListExt-v1610. The network configures these reference signals to be within the linked DL BWP (i.e., within the DL BWP with the same bwp-Id) of the UL BWP in which the BeamFailureRecoveryConfig is provided.

As many features in Rel-17 wanted to utilize Msg1 preambles to indicate early on the existence of certain features such as Msg3 repetitions, redcap, slicing and Small Data Transmissions. The solution was to introduce a common framework for allocating preambles in ROs and conditions for using these preambles groups as well as the combination of different features, such as Msg3 repetitions and Redcap. With this framework, it is possible to for instance define an RO #1 with a preamble group indicating Redcap and Msg3 repetitions, and then an RO #2 with a preamble group defining Small Data transmissions and Redcap+Msg3 Repetitions. The conditions to use these preamble groups are then defined.

In NR, a UE is allowed to transmit one PRACH preamble for an attempt. As PRACH was identified as a coverage bottleneck, its coverage can be enhanced by the multiple PRACH transmissions.

In some examples, solutions for PRACH repetions have been adopted in LTE eMTC and NB-IoT and can be refused to or enhanced for the support of multiple NR PRACH transmissions. For example, new solutions are needed to tailor the much larger number of NR PRACH configuration indices and more flexible PRACH occasions in time domain and frequency domain. What is more, some new problems are unique for NR, including PRACH transmissions with different UL Tx beams and association between PRACH occasions and SSBs.

Various embodiments described herein provide operations to determine a preamble, RO for multiple PRACH transmissions, and the corresponding power, TA, and phase. It also includes the mapping of PRACH transmission and UL Tx beam/SSB.

In some embodiments, a UE can transmit a PRACH preamble in a PRACH occasion associated with a selected synchronization signal block (“SSB”). A RAR is quasi-colocated (“QCLed”) with the SSB which the transmitted PRACH is associated with. Timing advances (“TAs”) and transmit power control (“TPC”) fields in a RAR are based on the received PRACH. If a UE doesn't receive a RAR that includes its random access preamble identifier (“RAPID”) within the RAR window, it can start the PRACH retransmission, which may be associated with the same SSB as initial transmission or a different SSB. Whether to use the same or different UL Tx beam for the retransmission is up to UE implementation.

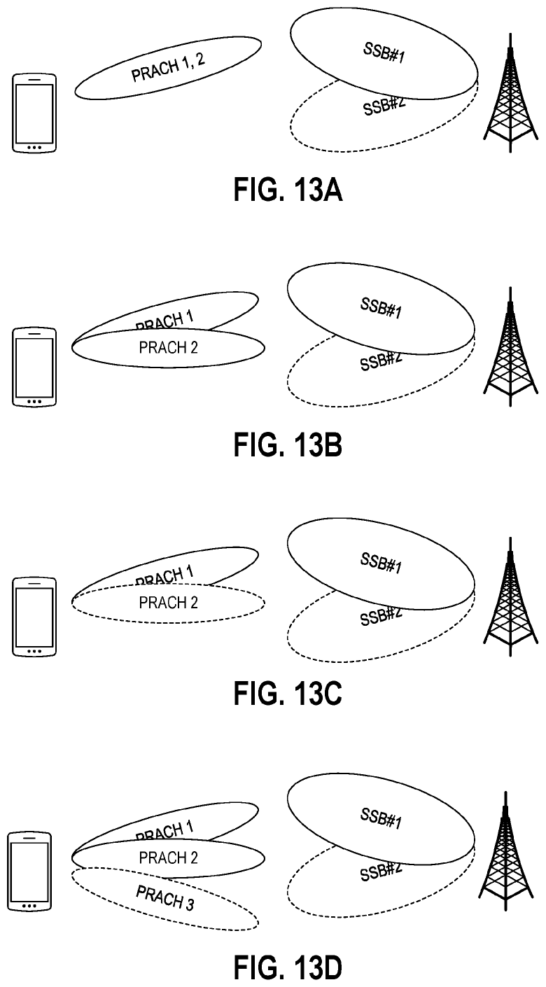

There are several scenarios of multiple PRACH transmissions in terms of UL Tx beam and SSB, as illustrated in FIGS. 13A-D. FIG. 13A illustrates an example in which a UE transmits multiple PRACHs with the same beam (e.g., with a same UL spatial relation), and all the PRACH transmissions are associated with the same SSB. FIG. 13B illustrates an example in which different beams are used for PRACH transmissions and associated with one SSB. The determination of UL Tx beams is up to UE implementation and is transparent to gNB. FIGS. 13C-D illustrate examples in which the multiple PRACH transmissions are associated with different SSB beams. In FIG. 13C, there is only PRACH associated with each selected SSB, while in FIG. 13D, at least one SSB is associated with more than one PRACH transmission. FIG. 13D is a combination of FIGS. 13B-C and embodiments associated with each can be applied to the example in FIG. 13D.

In some embodiments, it is up to UE implementation to determine UL Tx beam for Msg1. For UEs with assisted beam sweeping to have beam correspondence and UEs not able to refine their Tx beam during the limited time of random access, they may use a wide UL Tx beam, resulting in relatively small received power at the gNB until the UE can go through beam refinement procedures after an RRC connection is established. Multiple PRACH transmission with different UL Tx beams allows UE to sweep narrow beams with better directivity and higher received power at the gNB.

Depending on the value of ssb-perRACH-OccasionAndCB-PreamblesPerSSB, there is an association between PRACH occasion and SS block or between PRACH preamble index and SS block. It can be called PRACH transmission associated with an SSB. “Multiple PRACH transmissions” refers to those of one RACH attempt, that is, the PRACH transmissions are those made prior to receive a RAR, unless otherwise stated.

Some embodiments herein apply to contention-based random access (“CBRA”) and contention free random access (“CFRA”). CFRA resources for a beam failure recovery request can be associated with SSBs and/or CSI-RSs. However, for the sake of brevity, PRACH transmission associated SSB is referred to herein instead of PRACH transmission associated with SSB and/or CSI-RS.

Some embodiments herein apply to 4-step RACH and 2-step RACH.

Some embodiments associated with determination of single or multiple PRACH transmissions are described below.

In LTE, eMTC and NB-IoT, a network configures several N PRACH configurations with different numbers for repetitions for coverage enhancement for a cell. A UE will select the appropriate PRACH configuration for RA depending on the coverage level estimate from RSRP measurement. In a similar way, a NR UE can determine the number of PRACH transmission based on the measured RSRP and the configured thresholds.

In some embodiments, rsrp-ThresholdMsg3 is reused to determine whether to perform multiple PRACH transmissions, which is configured via a flag in RRC, either for the specific BWP or specific preamble-feature group. If RSRP is below rsrp-ThresholdMsg3, the UE repeats the PRACH. Also, a repetition procedure applies to a Msg3 transmission, and Msg3 is repeated a number of times that is indicated in a random access response or in a DCI format 0_0 with CRC scrambled by a TC-RNTI.

In additional or alternative embodiments, NUL and SUL can have separate new thresholds for multiple PRACH transmissions. This can be manifested through an offset relating to the threshold to determine whether to select NUL or SUL—rsrp-ThresholdSUL.

Except for depending on RSRP threshold, there are other ways for UEs to choose multiple PRACH transmissions. The network in general has quite limited information on the power headroom available for UEs during initial access, since there is normally no power headroom report available for UEs during initial access. By contrast, the UE is aware of how much power it has. In the cases it can't deliver the needed amount of power based on PRACH target reception power and pathloss estimation, which is above P_{CMAX,f,c}(i), it can trigger multiple PRACH transmissions. By allowing the UE to repeat only when needed, uplink resources and UE power wasted on unneeded repetition can be avoided.

In some embodiments, a UE determines single or multiple PRACH transmissions based on its power headroom. If P_{PRACH,target,f,c}+PL_{b,f,c} is larger than its maximum configured power P_{CMAX,f,c}(i) (abbreviated as ‘Pcmax’ in the following), the UE conducts multiple PRACH transmissions. Otherwise, the UE conducts single PRACH transmission.

In additional or alternative embodiments, the gap between needed power and Pcmax, namely P_{PRACH,target,f,c}+PL_{b,f,c}−P_{CMAX,f,c}(i), can be scaled into the different numbers of PRACH repetitions according to predetermined rules and configured numbers.

For example, a UE transmits 2 PRACHs if the gap is 0˜3 dB, 4 PRACHs if the gap is 3˜6 dB.

In some embodiments, a UE after transmission of first PRACH but failed to receive RAR or received RAR but not for itself, UE can initiate multiple PRACH transmissions for PRACH retransmission. The number of the retransmission and power of the retransmission may depend on the network configured parameter in this case. It can be configured or predetermined whether a UE can increase both the number of PRACH transmissions and transmission power for Msg1 retransmission or only one of them.

In some embodiments, a network enables the multiple PRACH transmissions though SIB for specific services. For example, if establishmentCause in RRCSetupRequest is set as emergency or for mission critical services, a UE can initiate the multiple PRACH transmission if network configures and allow it.

In NR up to Rel-17, a gNB may indicate BI field in RAR when it detects energy but fails to detect a preamble. A UE which doesn't receive a RAR with its RAPID can conduct PRACH retransmission after the backoff time. As stated below, for CBRA it is a random value between 0 and PREAMBLE_BACKOFF*SCALING_FACTOR_BI. SCALING_FACTOR_BI is set as 1 unless when it is configured in the beamFailureRecoveryConfig or rach-ConfigDedicated.
2> if the Random Access Response contains a MAC subPDU with Backoff Indicator:
   3> set the PREAMBLE_BACKOFF to value of the BI field of the MAC subPDU using Table 7.2-1, multiplied with SCALING_FACTOR_BI.
2> if the Random Access procedure is not completed:
   3> select a random backoff time according to a uniform distribution between 0 and the PREAMBLE_BACKOFF;
   3> if the criteria to select contention-free Random Access Resources is met during the backoff time:
      4> perform the Random Access Resource selection procedure;
   3> else:
      4> perform the Random Access Resource selection procedure after the backoff time.

The MAC subheader can include a Backoff Indicator (“BI”) field that identifies the overload condition in the cell. The size of the BI field is 4 bits.

If the NW is not overloaded, UEs in poor coverage can transmit more PRACH transmissions by using more RACH resources. In case the NW is overloaded, a UE which transmits a large number of PRACHs may cause a lot of preambles from other UEs to be mis-detected, then the NW may use a different strategy to make sure all UEs have the fair chance of network access, regardless of they are in good or poor cell coverage. A fair access can't be achieved if UEs transmitted different numbers of PRACH transmissions in previous attempt use the same backoff time for retransmission. A UE which uses more PRACH resources has to start retransmission after a larger backoff time.

In some embodiments, a larger backoff time is configured or indicated to UEs which transmitted a large number of PRACH transmissions in a previous attempt than UEs which transmitted a small number of PRACH transmission(s). For example, PREAMBLE_BACKOFF and/or SCALING_FACTOR_BI can be specific to a particular number of PRACH transmissions.

To reduce the impact on legacy UE and facilitate gNB preamble detection, specific preambles and/or ROs can be allocated for UEs capable of multiple PRACH transmissions.

As to the preamble determination for the multiple transmissions, a common way is to transmit the same preamble multiple times, just like LTE eMTC. In LTE eMTC, as the number of PRACH repetitions is determined by a UE, eNB can interpret the number by receiving a corresponding preamble. Namely, the preambles or PRACH resources are different among repetition levels, but this reduces the PRACH capacity.

In some embodiments, a UE can transmit different preambles across multiple ROs associated with the selected SSB.

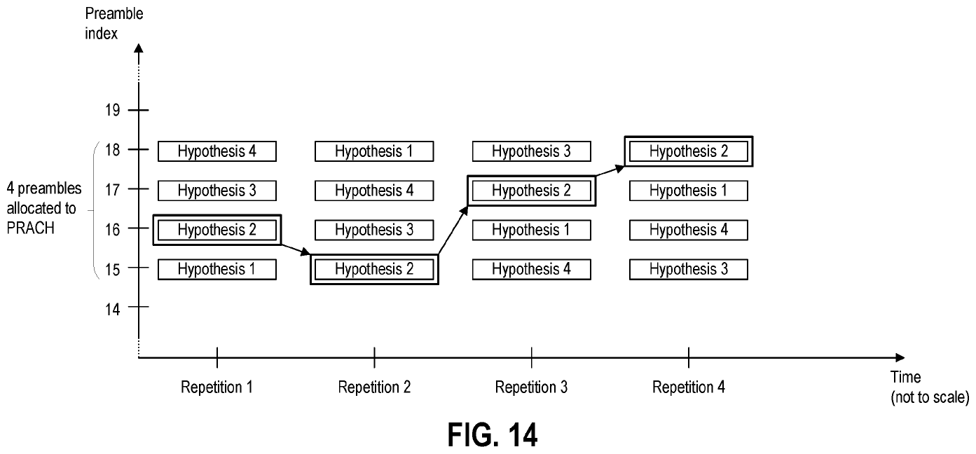

In additional or alternative embodiments, the UE selects a preamble index for a selected SSB for the first PRACH in the legacy way. For the remaining PRACH transmission(s), an offset of preamble index, logical/physical index of root sequence and/or cyclic shift is applied in relation to the previous PRACH, where the offset pattern can be configured/predetermined. This is illustrated in FIG. 14. The offset can be added modulo some value (e.g., modulo the number of available preambles for PRACH), or the offset may be added to form an updated index k according to k_{new}=mod(kₚᵣₑᵥ−Kₘᵢₙ+offset, K)+Kₘᵢₙ, where mod is the modulo operation, k represents the index of the preamble (according to any of the abovementioned methods), K is the number of consecutive preambles allocated for multiple PRACH repetitions and Kₘᵢₙ may be the lowest-index preamble allocated to multiple PRACH repetitions; in this way, all the multiple PRACH transmissions will use preambles within the range Kₘᵢₙ to Kₘᵢₙ+K−1. The offset may be different for the different repetitions, but may be the same for all UEs at a given time instance in the system frame structure to maintain orthogonality between UEs in a cell. Alternatively, one may define the index kᵢ for the ith repetition according to kᵢ=mod(k₀−Kₘᵢₙ+Δᵢ, K)+Kₘᵢₙ, where Δᵢ is an offset for the ith repetition, and k₀ is the index for the first repetition. See FIG. 14 for an illustration. The offset may be different in different cells to achieve interference diversity. Alternatively, the index i may refer to time instances relative to the system frame structure; this can be used to ensure orthogonality between UEs in a cell, even if they start their repetition sets at different points in time. RAPID is determined based on the first PRACH transmission. In addition to being based on repetition index and/or slot index, Δᵢ could be based on one or more of configuration, signaling, a random number determined by UE, UE identity (e.g., IMSI, IMEI). So UEs in a cell don't collide in all repetitions if their preambles collide in the first repetition.

64 preambles are generated based on cyclic shift and logical root sequence. The index 0˜63 is in the increasing order of cyclic shift first and then logic root sequence. With the same ordering, preambles with index 64˜127, 128˜191, 192˜255, . . . can be generated. For example, a UE uses preamble index 0, 64, 128, 192 for the 4 PRACH transmissions respectively. In another example, if one root index is able to provide 64 preambles with different cyclic shifts, the first preamble uses logic root index u and the second preamble transmitted by the UE uses logic root index u+1. gNB needs to do blind detection of the following possible preamble in the next RO for the SSB. Different repetition levels can share the same set of preambles and ROs.

In some embodiments, the PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For the indicated preamble index, the ordering of the PRACH occasions is: 1) in increasing order of frequency resource indexes for frequency multiplexed PRACH occasions; 2) in increasing order of time resource indexes for time multiplexed PRACH occasions within a PRACH slot; and 3) in increasing order of indexes for PRACH slots.

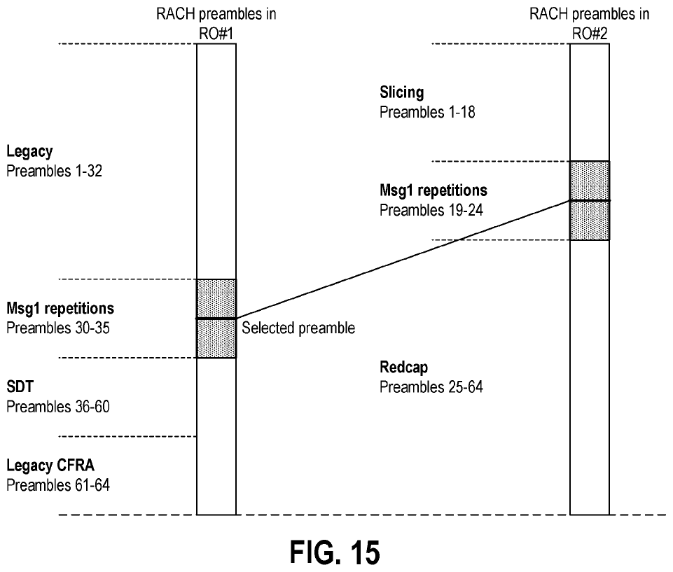

In additional or alternative embodiments, the preamble selected for each RO depends on where the msg1 preamble group is situated in the RO. This can be considered a virtual preamble, with the same relative index to the beginning preamble configured for the number of PRACH transmissions in the RO. For instance, we only consider K=2, namely gNB only supports two PRACH transmissions. If the preamble group for msg1 repetition in RO #1 is 30˜35, and then preamble group msg1 repetitions in RO #2 is 19˜24. If the UE selects preamble 30 in RO #1, the preamble 30 maps to the first preamble in RO #2, which is preamble 19. This is important as if there is not a specific RO only for msg1 repetitions, but rather preambles groups in different ROs, then there needs to be a mapping. This can be seen in FIG. 15.

In additional or alternative embodiments, when the UE selects a virtual preamble using the above, the UE will use the first preamble as the selected RAPID when detecting RAR. Furthermore, when selecting an RA-RNTI/msgB-RNTI, the first RACH occasion will be used to calculate the RA-RNTI.

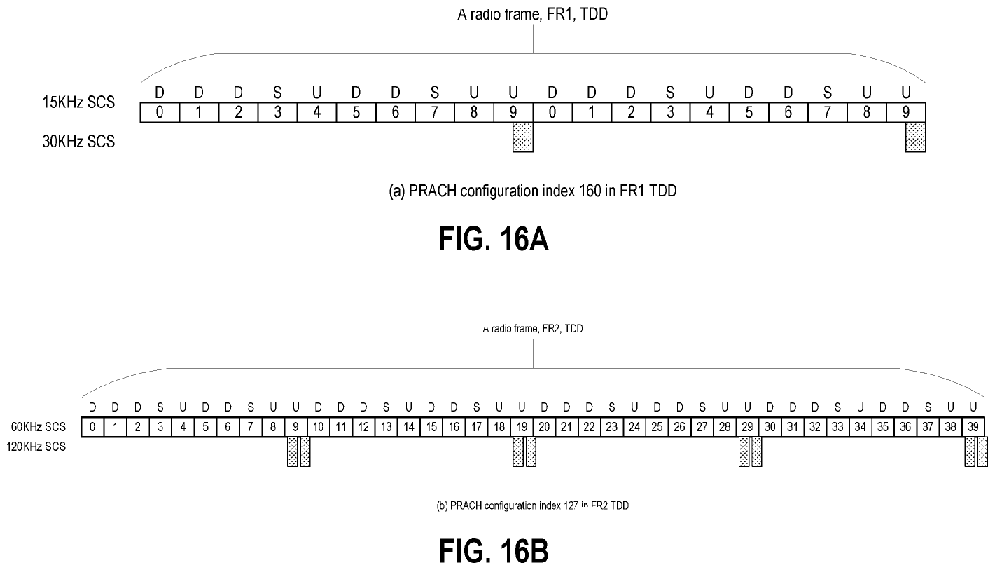

The pattern given by the PRACH Config Index repeats every RACH Configuration Period. FIG. 16A illustrates an example of PRACH configuration index #160 in FR1 TDD. With 30 KHz SCS, there are two time-domain PRACH occasions in a radio frame. FIG. 16B shows PRACH configuration index #127 in FR2. With 120 KHz SCS, there are eight time domain PRACH occasions in a radio frame. These time-domain PRACH occasions and FDMed ROs are divided among multiple SSBs and possibly among different repetition levels (namely number of PRACH transmissions). For simplicity, we assume in a time domain PRACH occasion there is at least one RO associated with the selected SSB and the determined repetition level. Otherwise, the time domain PRACH occasion associated with SSBs other than the selected one and those for other repetition levels are skipped for RO determination.

In additional or alternative embodiments, the preamble pattern is not based on a fixed offset (or modulo a fixed offset) from one transmission to the next in a set of repetitions as in the embodiment above, but rather follows some other pattern, e.g. a pattern that achieves even better interference diversity between cells. In this case, in order to limit the search space for the gNB, the pattern may be fixed relative to the frame structure in the cell. The UE may still be allowed to start the transmission at any time-domain RO in the pattern, or the UE may be limited to starting transmission only at certain time-domain ROs within the pattern and/or radio frame structure in the cell.

For a certain number of PRACH repetitions transmitted by a LTE eTMC UE, if there is random access resource in every subframe, the subframe of the first PRACH transmission is determined explicitly by a configured periodicity or implicitly by the repetition factor such that the time-domain PRACH resources for the number of PRACH repetitions are not overlapping. Similarly, in NR, a periodicity can also be configured for multiple PRACH transmissions, where multiple PRACH transmissions of a RACH attempt are within the period. The unit of the periodicity can be predetermined as association period, PRACH Configuration Period, radio frame, subframe, slots with SCS used for the slot numbering. Among the time-domain PRACH occasions associated with a selected SSB, for K PRACH transmissions, RO index i for the first PRACH transmission=mod (i, K)=0.

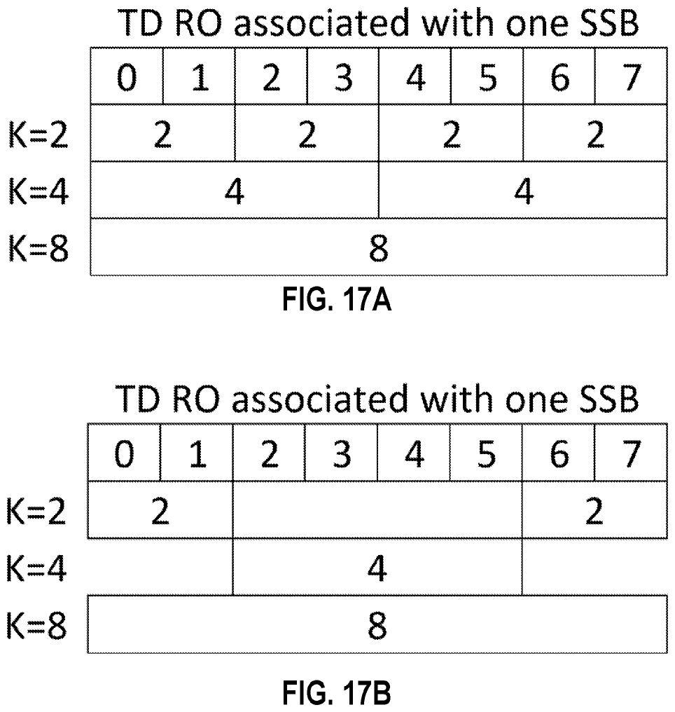

For example, for PRACH configuration index #127 in FR2 and TDD, if the periodicity is a PRACH Configuration Period, there are eight time-domain PRACH occasions in the period for the selected SSB. Assume 2, 4, 8 PRACH transmissions of a RACH attempt are supported. For 8 PRACH transmissions, the time-domain PRACH occasion of the first PRACH has index 0. For 4 PRACH transmissions, a UE can transmit the first one in RO #0 or RO #4. For 2 PRACH transmissions, the first RO is RO #0, 2, 4, 6. Each RO must have different preambles for 2, 4, and 8 PRACH transmissions, as illustrated in FIG. 17A. This adds further partitioning in the preamble group for multiple PRACH transmissions. This is a legacy problem in LTE eMTC but can be solved by NR preamble group.

In some embodiments, for multiple PRACH transmissions of an attempt, a set of PRACH occasions are determined in one or more of the following ways.

In some examples, K denotes the number of PRACH transmission(s) supported by a gNB, including K=1 and K>1. gNB is able to configure preambles for part of all K values in a RO. One method is that one ra-ssb-OccasionMaskIndex is associated with a K value. For a selected SSB, among the time-domain PRACH occasions in the period which have preamble(s) configured for K PRACH transmissions, RO for the first PRACH transmission of an attempt has its RO index i as mod (i, K)=0. For example, the right part of FIG. 17B shows for 2 PRACH transmissions, a UE can start transmission in RO #0 or RO #6. RO #2 and RO #4 have no preambles for 2-PRACH transmissions.

In additional or alternative examples, if there are multiple FDMed ROs associated with the selected SSB for at a time instance, a UE can use the same frequency resource or hop between the frequency domain PRACH resources across PRACH transmissions. Configuration of PRACH frequency hopping, including frequency hopping enabled/disabled, frequency hopping offset in the unit of PRB or RO, frequency hopping interval, which indicates how long a hop lasts, are configured in SIB1 or predetermined.

$${RO}_{start} ( i ) = \{ \begin{matrix}{RO}_{start} & ⌊ \frac{i}{K} ⌋ mod 2 = 0 \\ ( {RO}_{start} + {RO}_{offset} ) mod F & ⌊ \frac{i}{K} ⌋ mod 2 = 1\end{matrix} ,$$

where K denotes the number of time-domain PRACH occasions of a hop, ROₛₜₐᵣₜ(i) denotes the RO index in frequency domain for the i^{th} PRACH transmission of an attempt and F denotes the number of FDMed ROs for the specific number of PRACH transmissions associated with the selected SSB.

For example, assume the PRACH configuration index 127 illustrated in FIG. 16B, RO_{offset}=4 RO, msg1−FDM=8. K=2 for index 127. For 8 PRACH transmissions, a UE alternates between the two frequency hopping offsets after two PRACH transmissions.

In additional or alternative examples, as to the mixed PRACH preamble format, “Ax/By”, either it cannot be used with multiple PRACH transmissions, or a UE transmits multiple PRACH transmissions for Ax.

In NR up to Rel-17, available RO is determined by MAC entity, and a UE transmits PRACH if physical layer checks it is valid, and there is no collision which leads to PRACH dropping. UL beam switching time may also be a cause for PRACH dropping. One coverage enhancement in Rel-17 is PUSCH repetition based on available slots. DL slots and slots of SSB transmissions are not considered as available slots to avoid dropping PUSCH transmission. However, transmission based on available slot is not suitable for PRACH. Firstly, the PRACH time-domain resources occur in specific time instances. Secondly, PRACH collision between UEs needs consideration. If a PRACH transmission is dropped, postponing it may increase PRACH collision. Different from PUSCH transmission which repetition factor is scheduled by gNB, the repetition number of PRACH is determined by UE, if LTE eMTC rule is reused. Some methods are possible to reduce the impact of PRACH dropping, other than available slot counting.

In some embodiments, for the multiple PRACH transmissions, if a PRACH transmission in the available RO determined by MAC entity is dropped because physical layer thinks it is invalid or due to collision handling, it is not postponed.

For RedCap UE, if the RO overlaps with certain DL reception, it is up to UE implantation whether to transmit PRACH.

For Case 8 of valid RO overlapping with dynamically DL reception, leave it to UE implementation whether to receive the dynamically scheduled DL or transmit PRACH.

For Case 8 of valid RO overlapping with UE-dedicated configured DL reception (e.g. PDCCH in USS, SPS PDSCH, CSI-RS or DL PRS), leave it to UE implementation whether to receive the DL or transmit PRACH.

In additional or alternative embodiments, if a valid RO overlaps with dynamically scheduled or UE-dedicated configured DL reception, and a RedCap UE doesn't transmit PRACH in the RO, it is not postponed.

In some embodiments, it can be configured or predetermined whether a UE is allowed change its repetition level, which is determined for example according to RSRP threshold, if it determines PRACH transmission(s) is to be dropped. A predetermined method can be where a UE determines based on if the random access is triggered by physical layer or higher layer, CBRA or CFRA.

For example, a UE for CBRA is allowed to choose a higher repetition factor than the one determined based on RSRP threshold to make up for some or all of the dropped transmissions. Or if a UE wants to transmit four PRACH transmissions, but the latter two are to be dropped. So, it can choose a lower repetition factor of 2, which has similar performance but shorter latency. It can be up to UE implementation on how to make a balance between latency and repetition factor. However, even if the determined repetition factor and the change is up to UE implementation, it is beneficial that gNB is aware that a UE may change the repetition level, as it may determine the number of Msg3 repetitions based on the repetition level of PRACH. In addition, for some latency-sensitive triggering events, e.g., CFRA for HO or beam failure recovery, the UE-determined upgrade of repetition level is not desirable.

For NB-IoT and LTE eMTC, multiple PRACH transmissions of an attempt have the same transmission power based on the same pathloss estimation. However, if the multiple NR PRACH transmissions span a long time or the radio channel changes very fast, a UE may update the higher layer filtered RSRP multiple times depending on its filter input rate and the PRACH transmission power as well. The change of PRACH transmission power may affect the TPC command in RAR.

In some embodiments, it can be predetermined or configured whether a UE is allowed to change PRACH transmission power amid the multiple PRACH transmissions of an attempt.

When a gNB receives multiple repetitions of the same random access preamble from a UE, it can do coherent combining or non-coherent combining. Coherent combining means gNB combines the repetitions of RACH preamble and processes the combined signal without calculated modular value. With non-coherent combining, gNB estimate each repetitions independently, then add the modular value of each repetition.

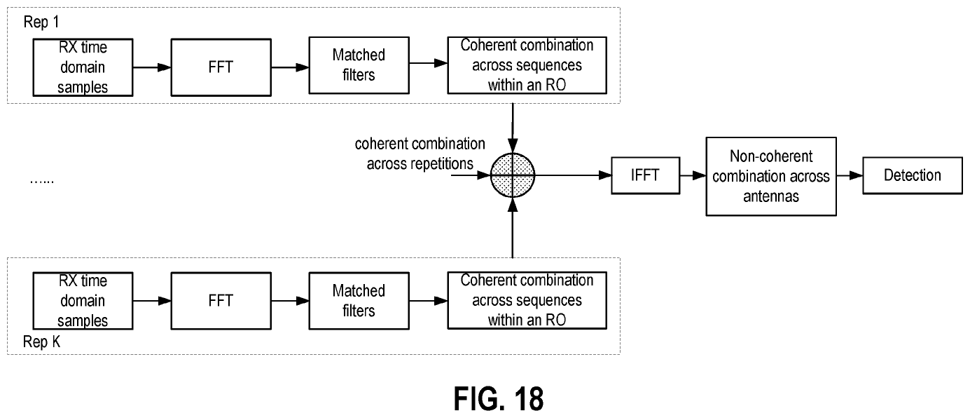

FIG. 18 illustrates an example of a coherent combination between repetitions.

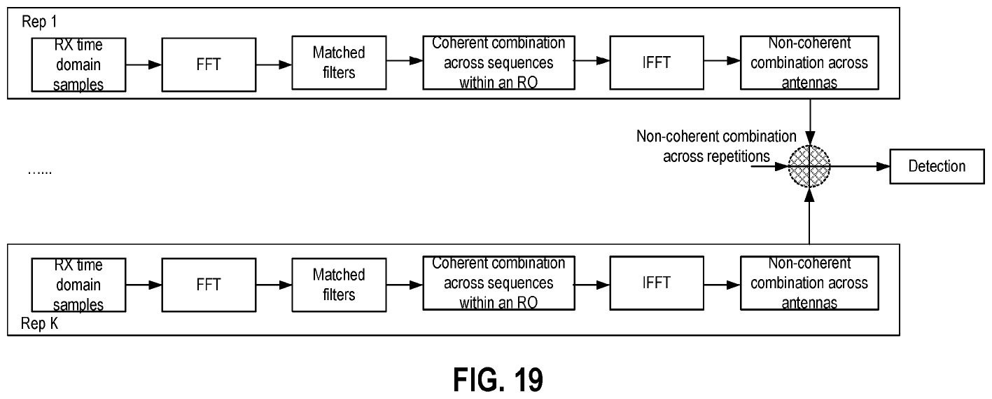

FIG. 19 illustrates an example of a non-coherent combination between repetitions.

For coherent combining, without UE guarantee of phase continuity across PRACH repetitions, gNB has to align the phases of all received PRACH repetitions by phase compensation before combining them. This would increase gNB implementation complexity. If a UE keeps phase continuity across some PRACH repetitions, gNB can do coherent combining for them without phase pre-compensation. The output sequence of coherent combining can be treated as one detected PRACH sequence and be non-coherently combined with the repetitions for that the UE can't keep the same phase. UE keeping phase continuity among PRACH repetitions is possible, especially if the corresponding ROs are in consecutive in time.

Some of the events, which violate phase continuity agreed for Rel-17 DMRS bundling, can be reused for multiple PRACH transmissions, including a gap of at least 14 symbols between two PUSCH transmissions. In addition, some other methods can be considered.

In some embodiments, gNB determines whether some/all PRACH transmissions from a UE are phase consistent in one or more of the following ways. In some examples, the gNB determines whether some/all PRACH transmissions from the UE are phase consistent based on explicit or implicit indication by guard of the preamble sequence. This can be used if the real cell radius is smaller than the maximum cell radius designed for a PRACH format.

In additional or alternative examples, the gNB determines whether some/all PRACH transmissions from the UE are phase consistent based on specific preambles that are configured for different levels of PRACH phase continuity. For example, preamble #0˜9 are configured for phase continuity among 2 PRACH repetitions and preamble #10-19 for phase continuity among 4 PRACH repetitions. Furthermore, if all the preamble #0˜19 are associated with a total of 4 PRACH repetitions according to SIB1, transmission of preamble #0˜9 indicates the UE may switch beam after the first two PRACH transmissions and the phase may change after beam switching.

In additional or alternative examples, the gNB determines whether some/all PRACH transmissions from the UE are phase consistent based on, for a UE which transmits multiple PRACHs, it is mandatory to support phase continuity unless violating events occur. Or if it is an optional UE capability, a UE implicitly indicates its capability with the first PRACH transmission.

In some embodiments, it can be predetermined if a UE is applied to adjust TA among multiple PRACH transmissions with the same beam.

Embodiments associated with multiple PRACH transmissions with different beams are described below.

In some embodiments, a UE can notify gNB (e.g., implicitly by a specific preamble if it will use different Tx beams for PRACH transmissions). Otherwise, gNB assumes the same Tx beam is used. In additional or alternative embodiments, the same Tx beam or different Tx beam is decided by UE capability of beam correspondence. For example, if capability beamCorrespondenceWithoutUL-BeamSweeping is supported in a UE, it transmits PRACHs with the same Tx beam.

In additional or alternative embodiments, the UE wants network assistance to reduce the beam refinement time and thus transmit multiple beam which potentially increase the received power at gNB. In this case, the number of the Tx beams may be decided by network via SIB. UE may select the Tx beam based on the received SSB RSRP, for example, if gNB allows PRACH transmissions with two Tx beams according to SIB configuration, and a UE has two panel received higher SSB RSRP but not other panel, UE could transmit one beam on each of the two panels.

In additional or alternative embodiments, the number of PRACH transmissions is determined based on the number of UE's Tx beams.

For example, if a UE determines the value according to SSB's RSRP measurement and the configured threshold, it will transmit the number of PRACH with each of its Tx beams. In another example, the number of PRACH transmissions is equal to the number of its Tx beams so that each PRACH is transmitted in a different beam. In some such embodiments, the network may indicate a number of repetitions that the UE should use when transmitting PRACH, which may be considered a candidate number of repetitions. If the number of different Tx beams that the UE can transmit is smaller than the indicated, or ‘candidate’, number of repetitions, the UE may transmit a number of PRACHs equal to the number of different Tx beams and not transmit the remaining PRACHs in the candidate number of repetitions indicated by the network.

There are 64 preambles in one PRACH transmission occasions. The network can detect 64 PRACHs transmitted in the same time-frequency PRACH occasion. To make it simple, we only consider preambles of the same root sequence, but with different cyclic shifts. For the unrestricted set, if N_{CS}=2, short sequence PRACH can have 64 cyclic shifts, denoted by Cᵥ=vN_{CS}, v=0, 1, . . . 63, with one root index. For a single PRACH transmission, the 64 simultaneously transmitted PRACHs are received by gNB and land in corresponding non-overlapping time-domain search windows. N_{CS} is indicated by gNB via zeroCorrelationZoneConfig based on UL delay spread of a channel for a single PRACH transmission.

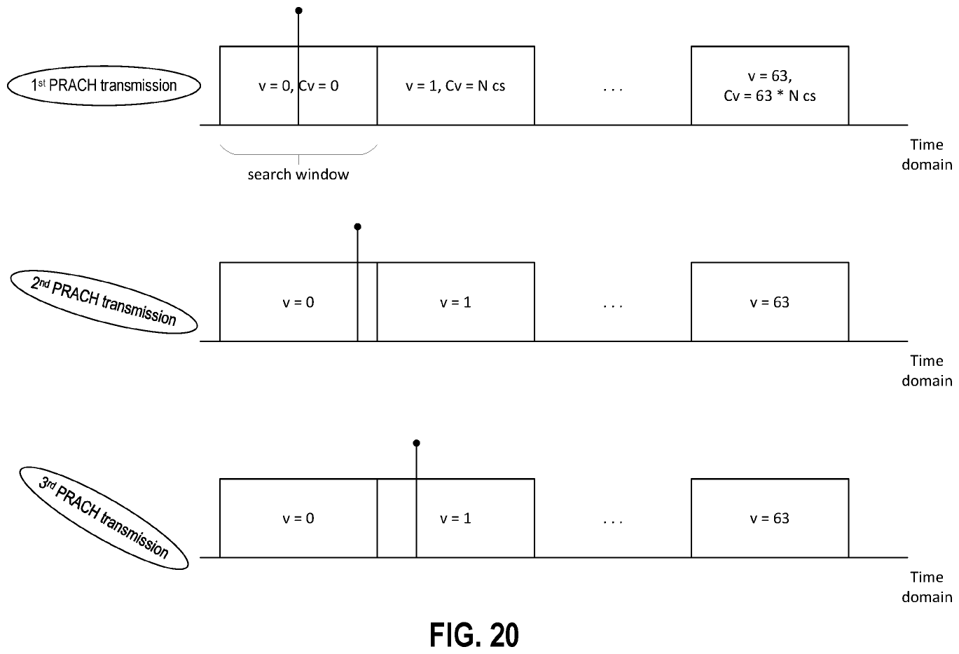

If a UE transmits PRACH with different Tx beams, in case some Tx beams are not well aimed at gNB or different TAs are applied to different Tx beams, the delay spread of multiple PRACH transmissions with different Tx beams may be larger than what gNB configures for single PRACH transmission. In FIG. 20, a UE transmits a preamble with v=0 in three ROs with different beams. The second PRACH transmission arrives with a longer delay than the first transmission but still lands in the right search window. The third transmission has an even longer delay than the configured Ncs and lands in another window and will be wrongly detected as preamble v=1. To avoid the wrong detection, a UE may have to restrict its Tx beams with a small degree of freedom so that they all can be received with a search window based on N_{CS}. But it is difficult for UE to determine the angle range. Therefore, in some embodiments, a N_{CS} is configured for multiple PRACH transmissions with different Tx beams, which is larger than the legacy one for single PRACH transmission.

In a separate RO, logical root sequence index obtained from the higher-layer parameter prach-RootSequenceIndex or rootSequenceIndex-BFR can apply to PRACH transmissions with different Tx beams in combination with a new N_{CS}. But in a shared RO case, the logical root sequence index needs consideration.

In additional or alternative embodiments, in the case of a shared RO with preambles of different N_{CS}, the logical root sequence index of the first preamble with the new N_{CS} can be one or more of the following.

In some examples, the logical root sequence index is configured separately in SIB1 or determined by a configured offset relative to prach-RootSequenceIndex or rootSequenceIndex-BFR.

In additional or alternative examples, the logical root sequence index is equal to (an offset+the largest logical root sequence index of the preambles with legacy N_{CS}), in the cyclic order according to the legacy rule that the logical index 0 is consecutive to 837 when L_{RA}=839 and is consecutive to 137 when L_{RA}=139, regardless of whether the largest logical root sequence index can still generate preambles with a new N_{CS}. The default offset can be 1.

In additional or alternative examples, the logical root sequence index is the same as the largest logical root sequence index of the preamble with legacy N_{CS}, if the largest logical root sequence index can still generate preambles with a new N_{CS} for the remaining preambles

UL beam switching time is needed for UE to conduct Tx beam switching, especially switching across UE panels. PRACH configuration index 127 in FR2 TDD as illustrated in FIG. 16B has a two-symbol gap between the two PRACH occasions in the two consecutive PRACH slots. In some embodiments, if beam switching time is larger than the gap, a UE may not be ready to transmit in the second PRACH occasion with a different beam, and therefore it transmits PRACH in the PRACH occasion without changing beam. Otherwise, in some embodiments, determining the number of PRACH transmissions that are actually transmitted by the UE comprises determining the number of PRACH transmissions based on the UL beam switching time and an amount of time between PRACH occasions such that the time between any two consecutive transmissions is greater than the beam switching time.

In some embodiments, one or more of the following ways are used to determine a PRACH occasion.

In some examples, s UE selects SSB considering its beam switching time so that the multiple PRACH transmissions with different Tx beams in the ROs associated with the selected SSB can be transmitted without new dropping rules, like UE autonomous dropping.

Since the determination of SSB is up to UE implementation, if a UE wants to switch Tx beams inside a panel or across panels, it can estimate if the gap of ROs for the selected SSB is sufficient for beam switching. In the case of beam switching time larger than gap of RO, it can choose Tx beams transmitting from a single panel or select a different SSB or a smaller number of repetitions so that the beam switching time would be smaller than gap of the RO, in another example, UE could activate the different panel first before making the beam switching, so beam switching time could be reduced and thus beam switching time is smaller than the gap of the RO. all up to UE implementation or its discretion. From gNB and standard perspective, a UE should not drop a PRACH transmission due to its own reason, e.g., when beam switching time is larger than the gap of ROs, which is agnostic to gNB and therefore impacts the detection rate.

If a UE can transmit multiple PRACHs associated with multiple SSBs, the selection of multiple SSBs follows the same rule.

In additional or alternative examples, the network could select the PRACH configuration index where the gap between consecutive PRACH ROs would be larger than the maximum UE beam switching time, so that there would be no UE autonomous dropping happening in different PRACH beam transmission.

In additional or alternative examples, the MAC entity may take into account the possible occurrence of UL beam switching time when determining the next available PRACH occasion.

In additional or alternative examples, the MAC entity doesn't consider UL beam switching time when determining next available PRACH occasion. A PRACH occasion is valid if it starts at least N symbols after the last symbol of the PRACH occasion corresponding to the previous PRACH transmission. N denotes UL beam switching time. It can be predetermined if the PRACH transmission in the PRACH occasions considered to be invalid by physical layer can be postponed.

In additional or alternative embodiments, if a UE's UL beam switching time is unknown to gNB, a predetermined value can be used by gNB to determine in which PRACH occasions to receive PRACH for the UE. A UE reports the time after RRC connection is established. A UE may report separate beam switching time for multiple PRACH transmission associated with one SSB and with multiple SSBs.

In NR up to Rel-17, according to 7.1.1 in 38.213, transmission power of PRACH depends on PL_{b,f,c}. A UE determines PL_{b.f,c} based on the SS/PBCH block associated with the PRACH transmission.

$${P}_{PRACH , b , f , c} ( i ) = min \{ {P}_{CMAX , f , c} ( i ) , {P}_{PRACH , target , f , c} + {PL}_{b , f , c} \} [ dBm ] ,$$

A UE may sweep its DL Rx beams for the same SSB index received over time and calculate different DL pathloss estimates with different DL Rx beams, which can be used to determine PRACH UL Tx power with corresponding UL Tx beams.

In some embodiments, PRACH transmission power can be one or more of the following ways.

In some examples, the same transmission power is used for all UL Tx beams based on a predetermined/minimum/maximum/average DL pathloss estimate. A UE keeps one PREAMBLE_POWER_RAMPING_COUNTER for all UL Tx beams.

In additional or alternative examples, the PRACH transmission power with a UL Tx beam is based on the DL pathloss estimate of the corresponding DL Rx beam. UE keeps a PREAMBLE_POWER_RAMPING_COUNTER for each UL Tx beam.

For transmission power of Msg 1 retransmission, the following existing rule for PRACH retransmission with one UL Tx beam in 38.213 can be reused for different UL Tx beams. If prior to a PRACH retransmission, a UE changes the spatial domain transmission filter, Layer 1 notifies higher layers to suspend the power ramping counter.

Msg1 retransmission may use different UL Tx beams from the previous attempt. With the second example above, since a UE maintains one power control loop for one UL Tx beam, the above rule can be reused. For example, if beam #0, #1 are used in an attempt, and beam #1, #2 are used for the following attempt, power ramping counter for beam #1 is increased by 1, but not for beam #2.

In the first example above, the specification can be updated as follows. If prior to a PRACH retransmission, a UE changes any of the spatial domain transmission filters, Layer 1 notifies higher layers to suspend the power ramping counter as described in. A UE may determine different values of timing advance for different beams, especially for UEs with multiple panels. If the difference of TA values is within the CP, a single TA can be applied to all beams. Otherwise, either the UE drops the use of a UL Tx beam which causes the difference among TAs larger than CP, or the UE can transmit PRACHs with different TA.

In some embodiments, it can be predetermined if a UE can apply different timing advances for PRACH transmissions with different beams.

In case a UE is power limited, namely, P_{PRACH,target,f,c}+PL_{b,f,c}≥P_{CMAX,f,c}(i), though it transmits PRACH with the same power, it is helpful that gNB knows which beam has the smallest PL. Even further, it may imply that the UE will use the DL Rx beam corresponding to the first PRACH transmission to receive Msg2.

In some embodiments, the order of different UL Tx beams for multiple PRACH transmissions is determined according to the increasing PL estimates with corresponding DL Rx beams. Or the first UL Tx beam corresponds to the DL Rx beam which has the smallest PL estimate.

In some embodiments, a mapping between UL Tx beams and the PRACH transmissions can be predetermined or configured. One predetermined way is a UE doesn't transmit two consecutive PRACHs in time domain with the same UL Tx beam. Namely every PRACH is transmitted with a unique beam. Another predetermined way is the same UL Tx beam is used across PRACH occasions in a PRACH slot or consecutive PRACH slots. UE can switch Tx beam over PRACH occasions in non-consecutive PRACH slots.

With the mapping, the number of UL Tx beams used by a UE can be implicitly known by gNB. With the knowledge, gNB can indicate one of the Tx beams for the following UL transmissions.

Embodiments associated with multiple PRACH transmissions with different Tx beams associated with different SSBs are described below.

In some embodiments, a UE transmits multiple PRACHs with different beams, which can be associated with multiple SSBs.

PRACH transmissions associated with multiple SSBs can bring more spatial diversity gain. On one hand, due to the short-term blocking or other implementation concerns, e.g., latency, the selected SSB may not be the strongest beam. Therefore, if the PRACH repetitions are associated with one SSB, though a UE can adjust UL Tx beams, they may not be the ideal beam to gNB. On the other hand, the received RSRP of two adjacent SSBs are similar, especially in the overlapping coverage area. Thus, PRACH transmissions associated with different SSBs can bring spatial diversity gain compared with one SSB.

In some embodiments, whether a UE is allowed to transmit multiple PRACH transmissions of an attempt associated with more than one SSB can be configured (e.g. in SIB1) to a UE or predetermined by one or more of the following parameters. These parameters can be SSB-common or SSB-specific. In some examples, an indication on whether a UE is allowed to transmit PRACH associated with different SSBs. If gNB configures so but doesn't configure a specific number of SSBs the PRACH transmission can be associated with, it is up to UE determination. In additional or alternative examples, the number of selected SSBs, with which the PRACH transmission is associated. For example, value 2 allows a UE to select two adjacent SSBs. The absence of the parameter or a default value indicates PRACH transmission is only allowed to be associated with one SSB. In additional or alternative examples, a maximum number of selected SSBs, with which the multiple PRACH transmissions are associated.

In additional or alternative examples, the SSB combinations. E.g., if a UE is configured with 2 SSBs for PRACH transmission and there are four SSBs in a cell, it can be configured with SSB combinations of {SSB #0, SSB1}, {SSB #1, SSB2}, {SSB #2, SSB3}, {SSB #3, SSB #0}. If it a UE configured with a maximum of 2 SSBs, some additional SSB combinations are {SSB #0, SSB0}, {SSB #1, SSB1}, {SSB #2, SSB2}, {SSB #3, SSB3}, in case the UE only selects one SSB. In other words, if a UE has selected a first SSB #X can select SSB #Y such that Y=mod(X−1, N) or Y=mod(X+1, N), where N is the number of SSBs. This assumes that the SSBs transmitted by the network are spatial adjacent. For mTRP scenario, a UE selects one SSB from a TRP, and gNB can provide the combination of the SSB index from each TRP.

Per-SSB configuration is beneficial if the coverage and UE density is uneven across SSBs of a cell. If the configuration is per cell, it applies to all its SSBs.

As the RSRP of multiple selected SSBs may be different, the corresponding repetition levels of SSBs are different. But this may increase gNB combination complexity.

In some embodiments, it can be predetermined if different numbers of PRACH transmissions are allowed for different selected SSBs. If the same number of PRACH transmissions applies to the selected SSBs, it can be based on the RSRP of a specific SSB and the number of UL Tx beams a UE will use for the PRACH transmissions associated with the SSBs.

For example, a UE may transmit a UE pairs its antenna panel and SSB. For the two selected SSBs, the two panels have different number antenna elements and therefore different number of UL Tx beams.

In some embodiments, the retransmission of Msg1 can be associated with the same or different number of SSBs. If the first RACH attempt has PRACH transmissions associated with the same SSB, the next attempt can have PRACH transmissions associated with multiple SSBs.

In some examples, a UE computes pathloss based on “SS block transmit power” and SS block RSRP. Different SS blocks in an SS burst set can be transmitted with different power and/or with different Tx beamforming gain at least as NW implementation. RMSI indicates only a single transmit power for SS blocks in Rel-15.

In NR, a RACH transmission occasion is defined as the time-frequency resource on which a PRACH message 1 is transmitted using the configured PRACH preamble format with a single particular tx beam.

In some embodiments, if PRACH transmissions are associated with multiple SSBs, the PRACH occasions can be determined in one or more of the following options.

Regarding the multiple PRACH transmissions associated with multiple SSBs, in some examples PRACH transmissions associated with one SSB are ahead of those associated with another SSB. In additional or alternative examples, PRACH transmissions associated with different selected SSBs can be interleaved.

Regarding the determination of RO for the first PRACH transmission, in some examples, the first PRACH can be associated with the SSB with the strongest RSRP. In additional or alternative examples, a UE determines the PRACH occasion associated with any of the selected SSB.

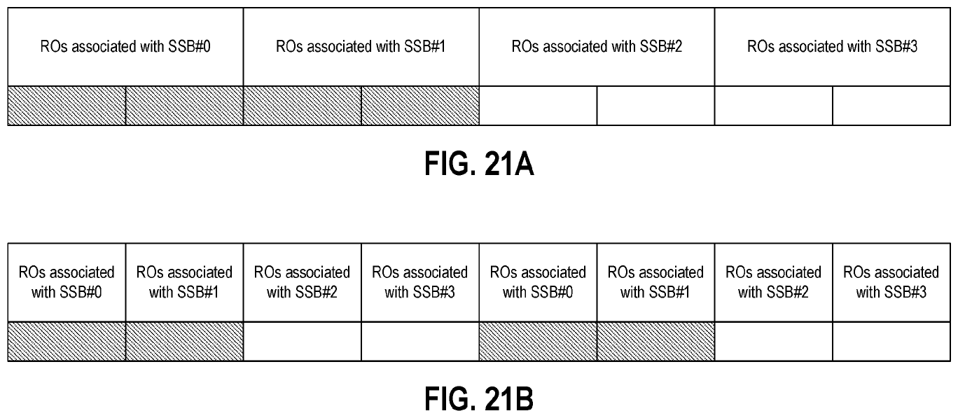

These examples can be used in different configurations. Consider that a UE selects SSB #0 and SSB #1 for RACH procedure. In some examples, one SSB mapping to two Ros can be applied as illustrated in FIG. 21A to reduce latency. If SSB #0 has higher RSRP than SSB #1, FIG. 21A also shows the selected RO according to Option a. But if SSB #1 has higher RSRP than SSB #0, the UE starts from RO associated with SSB #1 first and then the next available ROs with SSB #0, which are non-consecutive. However, if a UE determines the PRACH occasion associated with any of the selected SSBs, it can have the ROs selected as illustrated in FIG. 21A

In additional or alternative examples, one SSB can map to one RO as illustrated in FIG. 21B.

In some embodiments, the preambles associated with one SSB in a RO can be divided into those for PRACH transmissions associated with one SSB and those with multiple SSBs.

In the example of possible SSB combinations of {SSB #0}, {SSB #1}, {SSB #2}, {SSB #3}, {SSB #0, SSB1}, {SSB #1, SSB2}, {SSB #2, SSB3}, {SSB #3, SSB #0}, different PRACH resources will be configured for {SSB #0}, {SSB #0, SSB1} and {SSB #3, SSB #0}, so that gNB can tell if a UE will transmit PRACH repetitions for SSB #0 alone or with another adjacent SSB.

In some embodiments, when different preambles in an RO are associated with multiple SSBs, and PRACH repetition is enabled, a UE transmits one preamble in a RO for one selected SSB. It selects a preamble index offset, which is applied to the starting preamble for the selected SSBs.

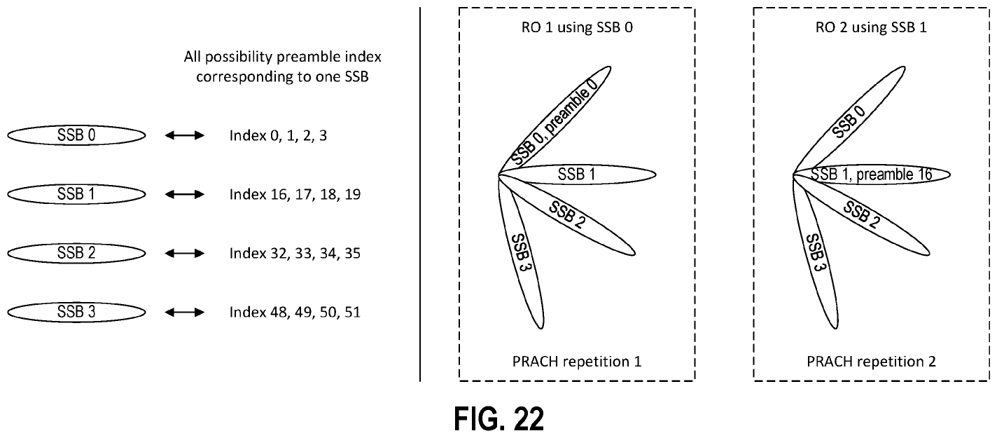

FIG. 22 shows ssb-perRACH-OccasionAndCB-PreamblesPerSSB configured as 4, namely 4 SSBs have corresponding 4 preambles in a RO. If a UE selects an offset 0, it can transmit preamble index #0, 16, 32, 48 for the corresponding SSBs if selected. More generally, the UE selects preamble index i for PRACH repetition 1, then SSB n is associated with preamble index mod

$$( i , {N}_{preamble}^{total} / N ) + n * {N}_{preamble}^{total} / N ,$$

N is the total number of SSBs.

In additional or alternative embodiments, the multiple PRACH transmissions can be ordered so that the associated SSBs have decreasing/increasing SSB RSRP or SSB index.

In some embodiments, PRACH transmit power is determined in one or more of the following ways.

In some examples, a UE keeps the same transmission power for all PRACH transmissions, which is determined independently based on the lowest or average PL of selected SSBs or PL of a reference SSB, e.g., the one with smallest index. A UE keeps one PREAMBLE_POWER_RAMPING_COUNTER for all UL Tx beams. The reference SSB for pathloss estimation can be determined in the same way as previous attempt but with the latest SSB(s) before PRACH retransmission.

In additional or alternative examples, a UE keeps the same transmission power for the PRACH transmissions associated with the same SSB, which is determined independently based on the received SSB's RSRP. A UE keeps one PREAMBLE_POWER_RAMPING_COUNTER for each selected SSB. The reference SSB for pathloss estimation can be the latest SSB with an index before the PRACH transmission associated with the same SSB index. Since a UE maintains a counter for each SSB, the legacy rule can be reused. In some examples, the rule can be updated as follows:
1> if all SSB or CSI-RS selected are not changed from the selection in the last Random Access Preamble transmission:

It means as long as one SSB of the set of SSBs for retransmission is different from those of previous attempt, power ramping counter is not increased.

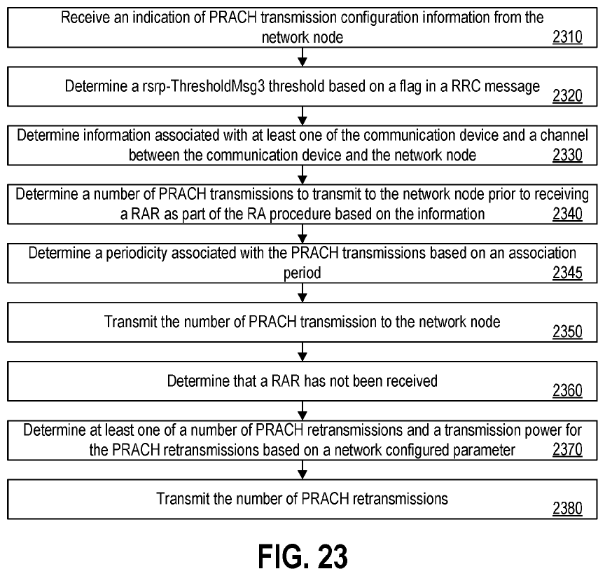

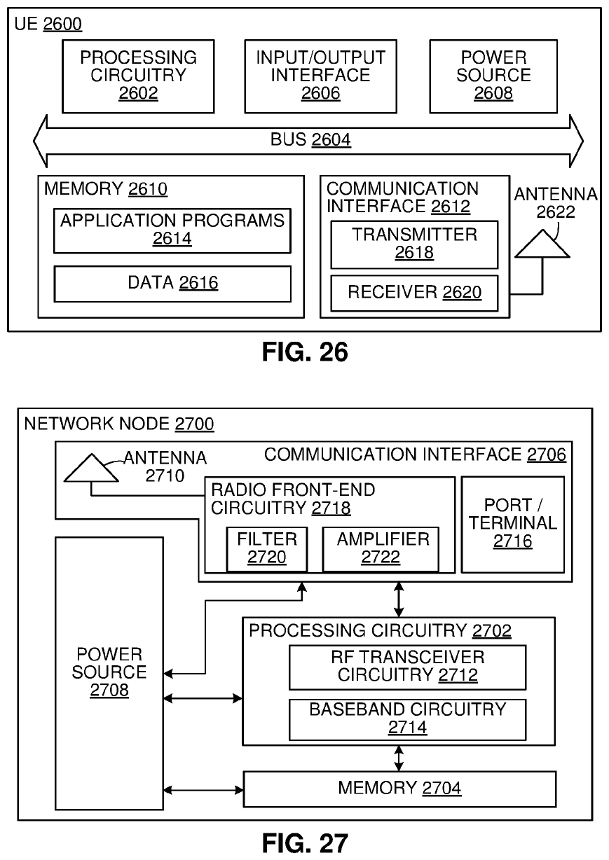

In the description that follows, while the communication device may be any of the wireless device 2512A, 2512B, wired or wireless devices UE 2512C, UE 2512D, UE 2600, virtualization hardware 2904, virtual machines 2908A, 2908B, or UE 3006, the UE 2600 (also referred to herein as communication device 2600) shall be used to describe the functionality of the operations of the communication device. Operations of the communication device 2600 (implemented using the structure of the block diagram of FIG. 26) will now be discussed with reference to the flow charts of FIG. 23 according to some embodiments of inventive concepts. For example, modules may be stored in memory 2610 of FIG. 26, and these modules may provide instructions so that when the instructions of a module are executed by respective communication device processing circuitry 2602, processing circuitry 2602 performs respective operations of the flow charts.

FIG. 23 illustrates an example of operations performed by a communication device during a RA procedure associated with a network node of a NR communications network.

At block 2310, processing circuitry 2602 receives, via communication interface 2612, an indication of PRACH transmission configuration information from the network node.

At block 2320, processing circuitry 2602 determines a rsrp-ThresholdMsg3 threshold based on a flag in a RRC message. In some embodiments, the RRC message is associated with a specific BWP or preamble-feature group.

At block 2330, processing circuitry 2602 determines information associated with at least one of the communication device and a channel between the communication device and the network node.

At block 2340, processing circuitry 2602 determines a number of PRACH transmissions to transmit to the network node (prior to receiving a RAR) as part of the RA procedure and based on the information. In some embodiments, determining the information includes determining a RSRP associated with the channel. Determining the number of PRACH transmissions includes: 1) determining the number of PRACH transmissions based on a comparison of the RSRP and a predetermined threshold; 2) determining that a repetition procedure applies to a Msg3 transmission according to the RSRP and the threshold; and 3) repeating the Msg3 transmission a number of times that is indicated in at least a random access response.

In additional or alternative embodiments, determining the information includes determining a power headroom of the communication device. Determining the number of PRACH transmissions includes determining the number of PRACH transmissions based on a comparison of an amount of power required for a PRACH transmission and the power headroom.

In additional or alternative embodiments, determining the number of PRACH transmissions to transmit to the network node includes receiving an indication of a candidate number of PRACH transmissions; and determining the number of PRACH transmissions as the lesser of the candidate number and a number of different Tx beams that the communication device is capable of using for PRACH transmissions.

In additional or alternative embodiments, determining the number of PRACH transmissions includes determining the number of PRACH transmissions based on an uplink, UL, beam switching time and an amount of time between PRACH occasions such that the time between any two consecutive transmissions is greater than the beam switching time.

At block 2345, processing circuitry 2602 determines a periodicity associated with the PRACH transmissions based on an association period.

At block 2350, processing circuitry 2602 transmits, via communication interface 2612, the number of PRACH transmissions to the network node. In some embodiments, transmitting the number of PRACH transmissions includes transmitting a plurality of different preambles across a plurality of ROs associated with a SSB associated with a portion of the PRACH transmissions.

In additional or alternative embodiments, the number of PRACH transmissions includes at least two PRACH transmissions. Transmitting the number of PRACH transmissions includes: 1) transmitting a first PRACH transmission of the at least two PRACH transmissions at a first RO of the plurality of ROs using a first preamble based on where a preamble group associated with the first PRACH transmission is within the first RO; and 2) transmitting a second PRACH transmission of the at least two PRACH transmissions at a second RO of the plurality of ROs using a second preamble based on where a preamble group associated with the second PRACH transmission is within the second RO.

In additional or alternative embodiments, the number of PRACH transmissions includes at least two PRACH transmissions that are each associated with different uplink, UL, transmission, Tx, beams. Transmitting the number of PRACH transmissions includes transmitting the at least two PRACH transmissions using the different UL Tx beams.

In additional or alternative embodiments, the number of PRACH transmissions includes at least two PRACH transmissions. Transmitting the number of PRACH transmissions includes: 1) transmitting a first PRACH transmission of the at least two PRACH transmissions using a first preamble index; 2) determining a second preamble index based on the first preamble index and an offset (e.g., a logical index of root sequence or a cyclic shift); and 3) transmitting a second PRACH transmission of the at least two PRACH transmissions using the second preamble index.

In additional or alternative embodiments, the number of PRACH transmissions includes at least two PRACH transmissions that are each associated with different transmission powers. Transmitting the number of PRACH transmissions includes: 1) transmitting the at least two PRACH transmissions using the different transmission powers; 2) determining each of the different transmission powers according to at least one of a corresponding pathloss value; and 3) determining the different transmission powers according to different values of a power ramping counter.

In additional or alternative embodiments, the number of PRACH transmissions includes at least two PRACH transmissions that are each associated with different timing advances, TAs. Transmitting the number of PRACH transmissions includes transmitting the at least two PRACH transmissions using the different TAs.

In additional or alternative embodiments, the number of PRACH transmissions includes at least two PRACH transmissions. Transmitting the number of PRACH transmissions includes transmitting the at least two PRACH transmissions in an order based on a path loss associated with each of the at least two PRACH transmissions.

In additional or alternative embodiments, the number of PRACH transmissions includes at least two PRACH transmissions that are each associated with different synchronization signal blocks, SSBs. Transmitting the number of PRACH transmissions includes transmitting the at least two PRACH transmissions using the Ul Tx beams associated with the different SSBs.

In additional or alternative embodiments, transmitting the number of PRACH transmissions includes transmitting an indication that the communication device will transmit the at least two PRACH transmissions using the different UL TX beams.

In additional or alternative embodiments, the number of PRACH transmissions includes at least two PRACH transmissions. Transmitting the number of PRACH transmissions includes: transmitting a first PRACH transmission of the at least two PRACH transmissions using a first preamble index; determining a second preamble index by applying the same offset between the first preamble index and a starting preamble index configured for multiple PRACH transmissions in the first RO to a starting preamble index configured for multiple PRACH transmissions in the second RO; and transmitting a second PRACH transmission of the at least two PRACH transmissions using the second preamble index.

In some embodiments, transmitting the number of PRACH transmissions includes transmitting the number of PRACH transmissions using the periodicity. In additional or alternative embodiments, transmitting the number of PRACH transmissions using the periodicity includes transmitting the number of PRACH transmissions during a time period, the time period being equal to one or more association periods.

In additional or alternative embodiments, transmitting the number of PRACH transmissions includes transmitting the number of PRACH transmissions during a time period starting at a resource occasion, RO, index i defined as mod (I, K)=0, where K is the number of PRACH transmissions.

In additional or alternative embodiments, there are a plurality of frequency division multiplexed, FDMed, resource occasions, ROs, associated with a selected synchronization signal block, SSB, for a time instance associated with the number of PRACH transmissions. In some examples, transmitting the number of PRACH transmissions includes hopping between the plurality of FDMed ROs across the number of PRACH transmission based on a number of FDMed ROs configured for the number of PRACH transmissions associated with the selected SSB.

In additional or alternative embodiments, transmitting the number of PRACH transmissions includes transmitting an ith PRACH transmission of the number of PRACH transmissions at a RO index in the frequency domain, ROₛₜₐᵣₜ(i), defined by:

$${RO}_{start} ( i ) = \{ \begin{matrix}{RO}_{start} & ⌊ \frac{i}{K} ⌋ mod 2 = 0 \\ ( {RO}_{start} + {RO}_{offset} ) mod F & ⌊ \frac{i}{K} ⌋ mod 2 = 1\end{matrix} ,$$

where K denotes the number of time-domain PRACH occasions of a hop and F denotes the number of FDMed ROs for the number of PRACH transmissions.

In additional or alternative embodiments, transmitting the number of PRACH transmissions includes: transmitting a first PRACH transmission of the number of PRACH transmissions; subsequent to transmitting the first PRACH transmission, determining that the first PRACH transmission is dropped; and responsive to determining that the first PRACH transmission is dropped, transmitting all remaining PRACH transmissions of the number of PRACH transmissions.

At block 2360, processing circuitry 2602 determines that a RAR has not been received. At block 2370, processing circuitry 2602 determines at least one of a number of PRACH retransmissions and a transmission power for the PRACH retransmissions based on a network configured parameter. At block 2380, processing circuitry 2602 transmits, via communication interface 2612, the number of PRACH retransmissions.

Various operations from the flow chart of FIG. 23 may be optional with respect to some embodiments of communication devices and related methods. In some examples, blocks 2310, 2320, 2360, 2370, and 2380 of FIG. 23 may be optional.

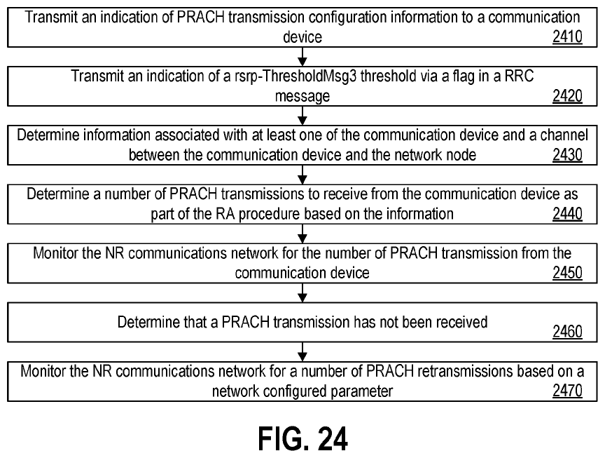

In the description that follows, while the network node may be any of the network node 2510A, 2510B, core network node 2508, network node 2700, virtualization hardware 2904, virtual machines 2908A, 2908B, or network node 3004, the network node 2700 shall be used to describe the functionality of the operations of the network node. Operations of the network node 2700 (implemented using the structure of the block diagram of FIG. 27) will now be discussed with reference to the flow chart of FIG. 24 according to some embodiments of inventive concepts. For example, modules may be stored in memory 2704 of FIG. 27, and these modules may provide instructions so that when the instructions of a module are executed by respective network node processing circuitry 2702, processing circuitry 2702 performs respective operations of the flow chart.

FIG. 24 illustrates an example of operations performed by a network node of a NR communications network during a RA procedure associated with a communication device.

At block 2410, processing circuitry 2702 transmits, via communication interface 2706, an indication of PRACH transmission configuration information to a communication device.

At block 2420, processing circuitry 2702 transmits, via communication interface 2706, an indication of a rsrp-ThresholdMsg3 threshold via a flag in a RRC message.

At block 2430, processing circuitry 2702 determines information associated with at least one of the communication device and a channel between the communication device and the network node.

At block 2440, processing circuitry 2702 determines a number of PRACH transmissions to receive from the communication device as part of the RA procedure based on the information. In some embodiments, determining the information includes determining a RSRP associated with the channel. Determining the number of PRACH transmissions includes determining the number of PRACH transmissions based on a comparison of the RSRP and a predetermined threshold.

In additional or alternative embodiments, determining the information includes determining a power headroom of the communication device. Determining the number of PRACH transmissions includes determining the number of PRACH transmissions based on a comparison of an amount of power required for the number of PRACH transmissions and the power headroom.

At block 2450, processing circuitry 2702 monitors, via communication interface 2706, the NR communications network for the number of PRACH transmissions from the communication device. In some embodiments, monitoring the NR communications network for the number of PRACH transmissions includes monitoring the NR communications network for a plurality of different preambles across a plurality of RA channel occasions, ROs, associated with a synchronization signal block associated with a portion of the PRACH transmissions.

In additional or alternative embodiments, the number of PRACH transmissions includes at least two PRACH transmissions that are each associated with different uplink, UL, transmission, Tx, beams. Monitoring the NR communications network for the number of PRACH transmissions includes monitoring the NR communications network for the at least two PRACH transmissions via the different UL Tx beams.

In additional or alternative embodiments, the number of PRACH transmissions includes at least two PRACH transmissions that are each associated with different transmission powers. Monitoring the NR communications network includes monitoring the NR communications network for the at least two PRACH transmissions using the different transmission powers.

In additional or alternative embodiments, the number of PRACH transmissions includes at least two PRACH transmissions that are each associated with different timing advances, TAs. Monitoring the NR communications network includes monitoring the NR communications network the at least two PRACH transmissions using the different TAs.

In additional or alternative embodiments, the number of PRACH transmissions includes at least two PRACH transmissions. Monitoring the NR communications network includes monitoring the NR communications network for the at least two PRACH transmissions in an order based on a path loss associated with each of the at least two PRACH transmissions.

In additional or alternative embodiments, the number of PRACH transmissions includes at least two PRACH transmissions that are each associated with different synchronization signal beams, SSBs. Monitoring the NR communications network includes monitoring the NR communications network for the at least two PRACH transmissions using the different SSBs.

At block 2460, processing circuitry 2702 determines that a PRACH transmission has not been received.

At block 2470, processing circuitry 2702 monitors, via communication interface 2706, the NR communications network for a number of PRACH retransmissions based on a network configured parameter.

Various operations from the flow chart of FIG. 24 may be optional with respect to some embodiments of network entities and related methods. In some examples, blocks 2410, 2420, 2460, and 2470 of FIG. 24 may be optional.

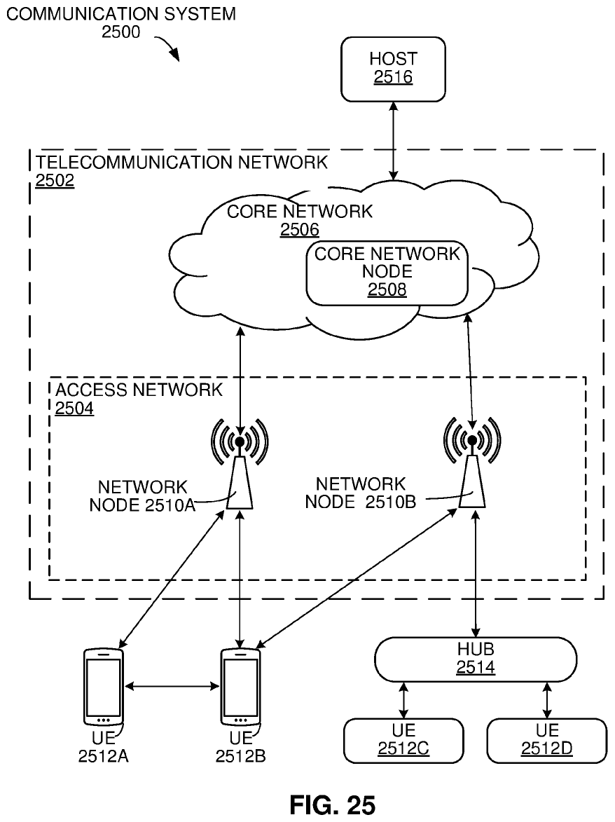

FIG. 25 shows an example of a communication system 2500 in accordance with some embodiments.

In the example, the communication system 2500 includes a telecommunication network 2502 that includes an access network 2504, such as a radio access network (RAN), and a core network 2506, which includes one or more core network nodes 2508. The access network 2504 includes one or more access network nodes, such as network nodes 2510a and 2510b (one or more of which may be generally referred to as network nodes 2510), or any other similar 3^{rd} Generation Partnership Project (3GPP) access node or non-3GPP access point. The network nodes 2510 facilitate direct or indirect connection of user equipment (UE), such as by connecting UEs 2512a, 2512b, 2512c, and 2512d (one or more of which may be generally referred to as UEs 2512) to the core network 2506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2500 may include any number of wired or wireless networks, network nodes, UEs, and/or any other components or systems that may facilitate or participate in the communication of data and/or signals whether via wired or wireless connections. The communication system 2500 may include and/or interface with any type of communication, telecommunication, data, cellular, radio network, and/or other similar type of system.

The UEs 2512 may be any of a wide variety of communication devices, including wireless devices arranged, configured, and/or operable to communicate wirelessly with the network nodes 2510 and other communication devices. Similarly, the network nodes 2510 are arranged, capable, configured, and/or operable to communicate directly or indirectly with the UEs 2512 and/or with other network nodes or equipment in the telecommunication network 2502 to enable and/or provide network access, such as wireless network access, and/or to perform other functions, such as administration in the telecommunication network 2502.

In the depicted example, the core network 2506 connects the network nodes 2510 to one or more hosts, such as host 2516. These connections may be direct or indirect via one or more intermediary networks or devices. In other examples, network nodes may be directly coupled to hosts. The core network 2506 includes one more core network nodes (e.g., core network node 2508) that are structured with hardware and software components. Features of these components may be substantially similar to those described with respect to the UEs, network nodes, and/or hosts, such that the descriptions thereof are generally applicable to the corresponding components of the core network node 2508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2516 may be under the ownership or control of a service provider other than an operator or provider of the access network 2504 and/or the telecommunication network 2502, and may be operated by the service provider or on behalf of the service provider. The host 2516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2500 of FIG. 25 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2502 is a cellular network that implements 3GPP standardized features. Accordingly, the telecommunications network 2502 may support network slicing to provide different logical networks to different devices that are connected to the telecommunication network 2502. For example, the telecommunications network 2502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2512 are configured to transmit and/or receive information without direct human interaction. For instance, a UE may be designed to transmit information to the access network 2504 on a predetermined schedule, when triggered by an internal or external event, or in response to requests from the access network 2504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2514 communicates with the access network 2504 to facilitate indirect communication between one or more UEs (e.g., UE 2512c and/or 2512d) and network nodes (e.g., network node 2510b). In some examples, the hub 2514 may be a controller, router, content source and analytics, or any of the other communication devices described herein regarding UEs. For example, the hub 2514 may be a broadband router enabling access to the core network 2506 for the UEs. As another example, the hub 2514 may be a controller that sends commands or instructions to one or more actuators in the UEs. Commands or instructions may be received from the UEs, network nodes 2510, or by executable code, script, process, or other instructions in the hub 2514. As another example, the hub 2514 may be a data collector that acts as temporary storage for UE data and, in some embodiments, may perform analysis or other processing of the data. As another example, the hub 2514 may be a content source. For example, for a UE that is a VR headset, display, loudspeaker or other media delivery device, the hub 2514 may retrieve VR assets, video, audio, or other media or data related to sensory information via a network node, which the hub 2514 then provides to the UE either directly, after performing local processing, and/or after adding additional local content. In still another example, the hub 2514 acts as a proxy server or orchestrator for the UEs, in particular in if one or more of the UEs are low energy IoT devices.

The hub 2514 may have a constant/persistent or intermittent connection to the network node 2510b. The hub 2514 may also allow for a different communication scheme and/or schedule between the hub 2514 and UEs (e.g., UE 2512c and/or 2512d), and between the hub 2514 and the core network 2506. In other examples, the hub 2514 is connected to the core network 2506 and/or one or more UEs via a wired connection. Moreover, the hub 2514 may be configured to connect to an M2M service provider over the access network 2504 and/or to another UE over a direct connection. In some scenarios, UEs may establish a wireless connection with the network nodes 2510 while still connected via the hub 2514 via a wired or wireless connection. In some embodiments, the hub 2514 may be a dedicated hub—that is, a hub whose primary function is to route communications to/from the UEs from/to the network node 2510b. In other embodiments, the hub 2514 may be a non-dedicated hub—that is, a device which is capable of operating to route communications between the UEs and network node 2510b, but which is additionally capable of operating as a communication start and/or end point for certain data channels.

FIG. 26 shows a UE 2600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the _{3rd}Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2600 includes processing circuitry 2602 that is operatively coupled via a bus 2604 to an input/output interface 2606, a power source 2608, a memory 2610, a communication interface 2612, and/or any other component, or any combination thereof. Certain Ues may utilize all or a subset of the components shown in FIG. 26. The level of integration between the components may vary from one UE to another UE. Further, certain Ues may contain multiple instances of a component, such as multiple processors, memories, transceivers, transmitters, receivers, etc.

The processing circuitry 2602 is configured to process instructions and data and may be configured to implement any sequential state machine operative to execute instructions stored as machine-readable computer programs in the memory 2610. The processing circuitry 2602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2602 may include multiple central processing units (CPUs).

In the example, the input/output interface 2606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2608 is structured as a battery or battery pack. Other types of power sources, such as an external power source (e.g., an electricity outlet), photovoltaic device, or power cell, may be used. The power source 2608 may further include power circuitry for delivering power from the power source 2608 itself, and/or an external power source, to the various parts of the UE 2600 via input circuitry or an interface such as an electrical power cable. Delivering power may be, for example, for charging of the power source 2608. Power circuitry may perform any formatting, converting, or other modification to the power from the power source 2608 to make the power suitable for the respective components of the UE 2600 to which power is supplied.

The memory 2610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2610 includes one or more application programs 2614, such as an operating system, web browser application, a widget, gadget engine, or other application, and corresponding data 2616. The memory 2610 may store, for use by the UE 2600, any of a variety of various operating systems or combinations of operating systems.

The memory 2610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2610 may allow the UE 2600 to access instructions, application programs and the like, stored on transitory or non-transitory memory media, to off-load data, or to upload data. An article of manufacture, such as one utilizing a communication system may be tangibly embodied as or in the memory 2610, which may be or comprise a device-readable storage medium.

The processing circuitry 2602 may be configured to communicate with an access network or other network using the communication interface 2612. The communication interface 2612 may comprise one or more communication subsystems and may include or be communicatively coupled to an antenna 2622. The communication interface 2612 may include one or more transceivers used to communicate, such as by communicating with one or more remote transceivers of another device capable of wireless communication (e.g., another UE or a network node in an access network). Each transceiver may include a transmitter 2618 and/or a receiver 2620 appropriate to provide network communications (e.g., optical, electrical, frequency allocations, and so forth). Moreover, the transmitter 2618 and receiver 2620 may be coupled to one or more antennas (e.g., antenna 2622) and may share circuit components, software or firmware, or alternatively be implemented separately.

In the illustrated embodiment, communication functions of the communication interface 2612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2600 shown in FIG. 26.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 27 shows a network node 2700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2700 includes a processing circuitry 2702, a memory 2704, a communication interface 2706, and a power source 2708. The network node 2700 may be composed of multiple physically separate components (e.g., a NodeB component and a RNC component, or a BTS component and a BSC component, etc.), which may each have their own respective components. In certain scenarios in which the network node 2700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2700 may be configured to support multiple radio access technologies (RATs). In such embodiments, some components may be duplicated (e.g., separate memory 2704 for different RATs) and some components may be reused (e.g., a same antenna 2710 may be shared by different RATs). The network node 2700 may also include multiple sets of the various illustrated components for different wireless technologies integrated into network node 2700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2700.

The processing circuitry 2702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2700 components, such as the memory 2704, to provide network node 2700 functionality.

In some embodiments, the processing circuitry 2702 includes a system on a chip (SOC). In some embodiments, the processing circuitry 2702 includes one or more of radio frequency (RF) transceiver circuitry 2712 and baseband processing circuitry 2714. In some embodiments, the radio frequency (RF) transceiver circuitry 2712 and the baseband processing circuitry 2714 may be on separate chips (or sets of chips), boards, or units, such as radio units and digital units. In alternative embodiments, part or all of RF transceiver circuitry 2712 and baseband processing circuitry 2714 may be on the same chip or set of chips, boards, or units.

The memory 2704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2702. The memory 2704 may store any suitable instructions, data, or information, including a computer program, software, an application including one or more of logic, rules, code, tables, and/or other instructions capable of being executed by the processing circuitry 2702 and utilized by the network node 2700. The memory 2704 may be used to store any calculations made by the processing circuitry 2702 and/or any data received via the communication interface 2706. In some embodiments, the processing circuitry 2702 and memory 2704 is integrated.

The communication interface 2706 is used in wired or wireless communication of signaling and/or data between a network node, access network, and/or UE. As illustrated, the communication interface 2706 comprises port(s)/terminal(s) 2716 to send and receive data, for example to and from a network over a wired connection. The communication interface 2706 also includes radio front-end circuitry 2718 that may be coupled to, or in certain embodiments a part of, the antenna 2710. Radio front-end circuitry 2718 comprises filters 2720 and amplifiers 2722. The radio front-end circuitry 2718 may be connected to an antenna 2710 and processing circuitry 2702. The radio front-end circuitry may be configured to condition signals communicated between antenna 2710 and processing circuitry 2702. The radio front-end circuitry 2718 may receive digital data that is to be sent out to other network nodes or UEs via a wireless connection. The radio front-end circuitry 2718 may convert the digital data into a radio signal having the appropriate channel and bandwidth parameters using a combination of filters 2720 and/or amplifiers 2722. The radio signal may then be transmitted via the antenna 2710. Similarly, when receiving data, the antenna 2710 may collect radio signals which are then converted into digital data by the radio front-end circuitry 2718. The digital data may be passed to the processing circuitry 2702. In other embodiments, the communication interface may comprise different components and/or different combinations of components.

In certain alternative embodiments, the network node 2700 does not include separate radio front-end circuitry 2718, instead, the processing circuitry 2702 includes radio front-end circuitry and is connected to the antenna 2710. Similarly, in some embodiments, all or some of the RF transceiver circuitry 2712 is part of the communication interface 2706. In still other embodiments, the communication interface 2706 includes one or more ports or terminals 2716, the radio front-end circuitry 2718, and the RF transceiver circuitry 2712, as part of a radio unit (not shown), and the communication interface 2706 communicates with the baseband processing circuitry 2714, which is part of a digital unit (not shown).

The antenna 2710 may include one or more antennas, or antenna arrays, configured to send and/or receive wireless signals. The antenna 2710 may be coupled to the radio front-end circuitry 2718 and may be any type of antenna capable of transmitting and receiving data and/or signals wirelessly. In certain embodiments, the antenna 2710 is separate from the network node 2700 and connectable to the network node 2700 through an interface or port.

The antenna 2710, communication interface 2706, and/or the processing circuitry 2702 may be configured to perform any receiving operations and/or certain obtaining operations described herein as being performed by the network node. Any information, data and/or signals may be received from a UE, another network node and/or any other network equipment. Similarly, the antenna 2710, the communication interface 2706, and/or the processing circuitry 2702 may be configured to perform any transmitting operations described herein as being performed by the network node. Any information, data and/or signals may be transmitted to a UE, another network node and/or any other network equipment.

The power source 2708 provides power to the various components of network node 2700 in a form suitable for the respective components (e.g., at a voltage and current level needed for each respective component). The power source 2708 may further comprise, or be coupled to, power management circuitry to supply the components of the network node 2700 with power for performing the functionality described herein. For example, the network node 2700 may be connectable to an external power source (e.g., the power grid, an electricity outlet) via an input circuitry or interface such as an electrical cable, whereby the external power source supplies power to power circuitry of the power source 2708. As a further example, the power source 2708 may comprise a source of power in the form of a battery or battery pack which is connected to, or integrated in, power circuitry. The battery may provide backup power should the external power source fail.

Embodiments of the network node 2700 may include additional components beyond those shown in FIG. 27 for providing certain aspects of the network node's functionality, including any of the functionality described herein and/or any functionality necessary to support the subject matter described herein. For example, the network node 2700 may include user interface equipment to allow input of information into the network node 2700 and to allow output of information from the network node 2700. This may allow a user to perform diagnostic, maintenance, repair, and other administrative functions for the network node 2700.

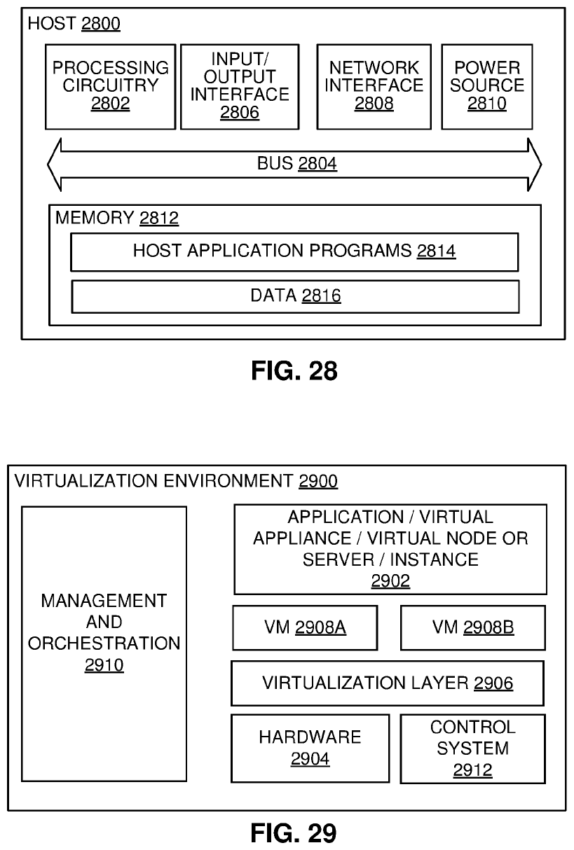

FIG. 28 is a block diagram of a host 2800, which may be an embodiment of the host 2516 of FIG. 25, in accordance with various aspects described herein. As used herein, the host 2800 may be or comprise various combinations hardware and/or software, including a standalone server, a blade server, a cloud-implemented server, a distributed server, a virtual machine, container, or processing resources in a server farm. The host 2800 may provide one or more services to one or more UEs.

The host 2800 includes processing circuitry 2802 that is operatively coupled via a bus 2804 to an input/output interface 2806, a network interface 2808, a power source 2810, and a memory 2812. Other components may be included in other embodiments. Features of these components may be substantially similar to those described with respect to the devices of previous figures, such as FIGS. 26 and 27, such that the descriptions thereof are generally applicable to the corresponding components of host 2800.

The memory 2812 may include one or more computer programs including one or more host application programs 2814 and data 2816, which may include user data, e.g., data generated by a UE for the host 2800 or data generated by the host 2800 for a UE. Embodiments of the host 2800 may utilize only a subset or all of the components shown. The host application programs 2814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2814 may also provide for user authentication and licensing checks and may periodically report health, routes, and content availability to a central node, such as a device in or on the edge of a core network. Accordingly, the host 2800 may select and/or indicate a different host for over-the-top services for a UE. The host application programs 2814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 29 is a block diagram illustrating a virtualization environment 2900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2906 (also referred to as hypervisors or virtual machine monitors (VMMs)), provide VMs 2908a and 2908b (one or more of which may be generally referred to as VMs 2908), and/or perform any of the functions, features and/or benefits described in relation with some embodiments described herein. The virtualization layer 2906 may present a virtual operating platform that appears like networking hardware to the VMs 2908.

The VMs 2908 comprise virtual processing, virtual memory, virtual networking or interface and virtual storage, and may be run by a corresponding virtualization layer 2906. Different embodiments of the instance of a virtual appliance 2902 may be implemented on one or more of VMs 2908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2908 may be a software implementation of a physical machine that runs programs as if they were executing on a physical, non-virtualized machine. Each of the VMs 2908, and that part of hardware 2904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2908 on top of the hardware 2904 and corresponds to the application 2902.

Hardware 2904 may be implemented in a standalone network node with generic or specific components. Hardware 2904 may implement some functions via virtualization. Alternatively, hardware 2904 may be part of a larger cluster of hardware (e.g. such as in a data center or CPE) where many hardware nodes work together and are managed via management and orchestration 2910, which, among others, oversees lifecycle management of applications 2902. In some embodiments, hardware 2904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2912 which may alternatively be used for communication between hardware nodes and radio units.

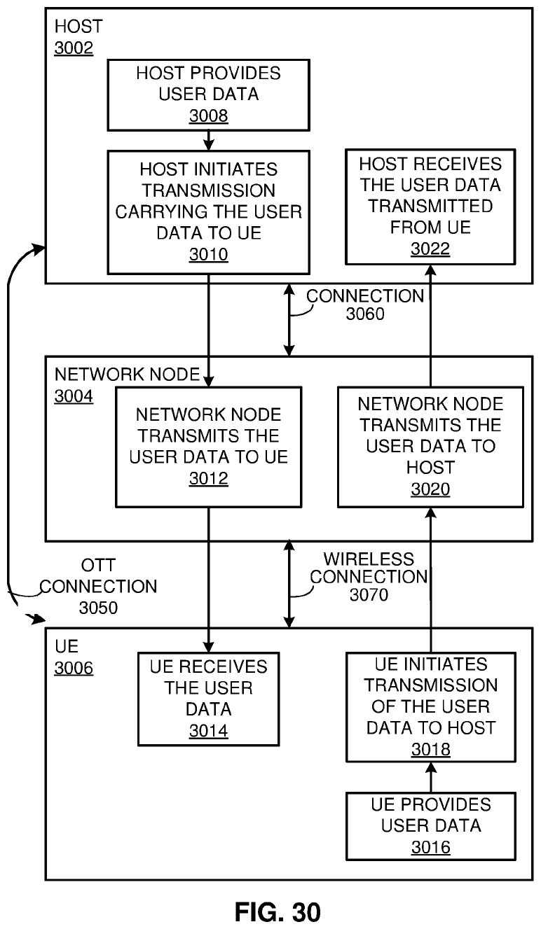

FIG. 30 shows a communication diagram of a host 3002 communicating via a network node 3004 with a UE 3006 over a partially wireless connection in accordance with some embodiments. Example implementations, in accordance with various embodiments, of the UE (such as a UE 2512a of FIG. 25 and/or UE 2600 of FIG. 26), network node (such as network node 2510a of FIG. 25 and/or network node 2700 of FIG. 27), and host (such as host 2516 of FIG. 25 and/or host 2800 of FIG. 28) discussed in the preceding paragraphs will now be described with reference to FIG. 30.

Like host 2800, embodiments of host 3002 include hardware, such as a communication interface, processing circuitry, and memory. The host 3002 also includes software, which is stored in or accessible by the host 3002 and executable by the processing circuitry. The software includes a host application that may be operable to provide a service to a remote user, such as the UE 3006 connecting via an over-the-top (OTT) connection 3050 extending between the UE 3006 and host 3002. In providing the service to the remote user, a host application may provide user data which is transmitted using the OTT connection 3050.

The network node 3004 includes hardware enabling it to communicate with the host 3002 and UE 3006. The connection 3060 may be direct or pass through a core network (like core network 2506 of FIG. 25) and/or one or more other intermediate networks, such as one or more public, private, or hosted networks. For example, an intermediate network may be a backbone network or the Internet.

The UE 3006 includes hardware and software, which is stored in or accessible by UE 3006 and executable by the UE's processing circuitry. The software includes a client application, such as a web browser or operator-specific “app” that may be operable to provide a service to a human or non-human user via UE 3006 with the support of the host 3002. In the host 3002, an executing host application may communicate with the executing client application via the OTT connection 3050 terminating at the UE 3006 and host 3002. In providing the service to the user, the UE's client application may receive request data from the host's host application and provide user data in response to the request data. The OTT connection 3050 may transfer both the request data and the user data. The UE's client application may interact with the user to generate the user data that it provides to the host application through the OTT connection 3050.

The OTT connection 3050 may extend via a connection 3060 between the host 3002 and the network node 3004 and via a wireless connection 3070 between the network node 3004 and the UE 3006 to provide the connection between the host 3002 and the UE 3006. The connection 3060 and wireless connection 3070, over which the OTT connection 3050 may be provided, have been drawn abstractly to illustrate the communication between the host 3002 and the UE 3006 via the network node 3004, without explicit reference to any intermediary devices and the precise routing of messages via these devices.

As an example of transmitting data via the OTT connection 3050, in step 3008, the host 3002 provides user data, which may be performed by executing a host application. In some embodiments, the user data is associated with a particular human user interacting with the UE 3006. In other embodiments, the user data is associated with a UE 3006 that shares data with the host 3002 without explicit human interaction. In step 3010, the host 3002 initiates a transmission carrying the user data towards the UE 3006. The host 3002 may initiate the transmission responsive to a request transmitted by the UE 3006. The request may be caused by human interaction with the UE 3006 or by operation of the client application executing on the UE 3006. The transmission may pass via the network node 3004, in accordance with the teachings of the embodiments described throughout this disclosure. Accordingly, in step 3012, the network node 3004 transmits to the UE 3006 the user data that was carried in the transmission that the host 3002 initiated, in accordance with the teachings of the embodiments described throughout this disclosure. In step 3014, the UE 3006 receives the user data carried in the transmission, which may be performed by a client application executed on the UE 3006 associated with the host application executed by the host 3002.

In some examples, the UE 3006 executes a client application which provides user data to the host 3002. The user data may be provided in reaction or response to the data received from the host 3002. Accordingly, in step 3016, the UE 3006 may provide user data, which may be performed by executing the client application. In providing the user data, the client application may further consider user input received from the user via an input/output interface of the UE 3006. Regardless of the specific manner in which the user data was provided, the UE 3006 initiates, in step 3018, transmission of the user data towards the host 3002 via the network node 3004. In step 3020, in accordance with the teachings of the embodiments described throughout this disclosure, the network node 3004 receives user data from the UE 3006 and initiates transmission of the received user data towards the host 3002. In step 3022, the host 3002 receives the user data carried in the transmission initiated by the UE 3006.

One or more of the various embodiments improve the performance of OTT services provided to the UE 3006 using the OTT connection 3050, in which the wireless connection 3070 forms the last segment. More precisely, the teachings of these embodiments may allow identification of a UL Tx beam to use for Msg3 transmissions.

In an example scenario, factory status information may be collected and analyzed by the host 3002. As another example, the host 3002 may process audio and video data which may have been retrieved from a UE for use in creating maps. As another example, the host 3002 may collect and analyze real-time data to assist in controlling vehicle congestion (e.g., controlling traffic lights). As another example, the host 3002 may store surveillance video uploaded by a UE. As another example, the host 3002 may store or control access to media content such as video, audio, VR or AR which it can broadcast, multicast or unicast to Ues. As other examples, the host 3002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3050 between the host 3002 and UE 3006, in response to variations in the measurement results. The measurement procedure and/or the network functionality for reconfiguring the OTT connection may be implemented in software and hardware of the host 3002 and/or UE 3006. In some embodiments, sensors (not shown) may be deployed in or in association with other devices through which the OTT connection 3050 passes; the sensors may participate in the measurement procedure by supplying values of the monitored quantities exemplified above, or supplying values of other physical quantities from which software may compute or estimate the monitored quantities. The reconfiguring of the OTT connection 3050 may include message format, retransmission settings, preferred routing etc.; the reconfiguring need not directly alter the operation of the network node 3004. Such procedures and functionalities may be known and practiced in the art. In certain embodiments, measurements may involve proprietary UE signaling that facilitates measurements of throughput, propagation times, latency and the like, by the host 3002. The measurements may be implemented in that software causes messages to be transmitted, in particular empty or ‘dummy’ messages, using the OTT connection 3050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a communication device during a random access, RA, procedure associated with a network node of a new radio, NR, communications network, the method comprising:
determining information associated with at least one of the communication device and a channel between the communication device and the network node;
determining a number of physical RA channel, PRACH, transmissions to transmit to the network node prior to receiving a random access response as part of the RA procedure based on the information, wherein the PRACH transmissions are associated with the same Synchronization Signal Block, SSB; and
transmitting the number of PRACH transmissions to the network node as part of the RA procedure,
wherein the number of PRACH transmissions comprises at least two PRACH transmissions that are each associated with different transmission powers.

2. The method of claim 1, further comprising:
determining a periodicity associated with the PRACH transmissions based on an association period,
wherein transmitting the number of PRACH transmissions comprises transmitting the number of PRACH transmissions using the periodicity.

3. The method of claim 2, wherein transmitting the number of PRACH transmissions using the periodicity comprises at least one of:
transmitting the number of PRACH transmissions during a time period, the time period being equal to one or more association periods; and
transmitting the number of PRACH transmission during a time period starting at a resource occasion, RO, index I defined as mod (I, K)=0, where K is the number of PRACH transmissions.

4. (canceled)

5. The method of claim 1, wherein there are a plurality of frequency division multiplexed, FDMed, resource occasions, ROs, associated with the SSB for a time instance associated with the number of PRACH transmissions, and
wherein transmitting the number of PRACH transmissions comprises hopping between the plurality of FDMed ROs across the number of PRACH transmissions based on a number of FDMed ROs configured for the number of PRACH transmissions associated with the SSB.

6. The method of claim 5, wherein transmitting the number of PRACH transmissions comprises transmitting an ith PRACH transmission of the number of PRACH transmissions at a RO index in the frequency domain, ROₛₜₐᵣₜ(i), defined by:
$${RO}_{start} ( i ) = \{ \begin{matrix}{RO}_{start} & ⌊ \frac{i}{K} ⌋ mod 2 = 0 \\ ( {RO}_{start} + {RO}_{offset} ) mod F & ⌊ \frac{i}{K} ⌋ mod 2 = 1\end{matrix} ,$$
where K denotes the number of time-domain PRACH occasions of a hop and F denotes the number of FDMed ROs for the number of PRACH transmissions.

7. The method of claim 1, wherein transmitting the number of PRACH transmissions comprises:
transmitting a first PRACH transmission of the number of PRACH transmissions;
subsequent to transmitting the first PRACH transmission, determining that the first PRACH transmission is dropped; and
responsive to determining that the first PRACH transmission is dropped, transmitting all remaining PRACH transmissions of the number of PRACH transmissions.

8. The method of claim 1, wherein determining the information comprises determining a reference signal received power, RSRP, associated with the channel, and
wherein determining the number of PRACH transmissions comprises:
determining the number of PRACH transmissions based on a comparison of the RSRP and a predetermined threshold;
determining that a repetition procedure applies to a Msg3 transmission according to the RSRP and the threshold; and
repeating the Msg3 transmission a number of times that is indicated in at least a random access response.

9. (canceled)

10. The method of claim 1, wherein determining the information comprises determining a power headroom of the communication device, and
wherein determining the number of PRACH transmissions comprises determining the number of PRACH transmissions based on a comparison of an amount of power required for a PRACH transmission and the power headroom.

11. The method of claim 1, further comprising:
responsive to transmitting the number of PRACH transmissions, determining that a RA response, RAR, has not been received during a predetermined period of time;
responsive to determining that the RAR has not been received during the predetermined period of time, determining at least one of a number of PRACH retransmissions and a transmission power for the PRACH retransmissions based on a network configured parameter; and
transmitting the number of PRACH retransmissions.

12. (canceled)

13. The method of claim 1, wherein transmitting the number of PRACH transmissions comprises transmitting a plurality of different preambles across a plurality of RA channel occasions, ROs, associated with a synchronization signal block associated the PRACH transmissions, and
wherein transmitting the number of PRACH transmissions comprises:
transmitting a first PRACH transmission of the at least two PRACH transmissions at a first RO of the plurality of ROs using a first preamble based on where a preamble group associated with the first PRACH transmission is within the first RO; and
transmitting a second PRACH transmission of the at least two PRACH transmissions at a second RO of the plurality of ROs using a second preamble based on where a preamble group associated with the second PRACH transmission is within the second RO.

14-19. (canceled)

20. The method of claim 1, wherein transmitting the number of PRACH transmissions comprises:
transmitting the at least two PRACH transmissions using the different transmission powers; and
determining each of the different transmission powers according to at least one of a corresponding pathloss value.

21. (canceled)

22. The method of claim 1, wherein the at least two PRACH transmissions are each associated with different timing advances, TAs, and
wherein transmitting the number of PRACH transmissions comprises transmitting the at least two PRACH transmissions using the different TAs.

23. The method of claim 1, wherein transmitting the number of PRACH transmissions comprises transmitting the at least two PRACH transmissions in an order based on a path loss associated with each of the at least two PRACH transmissions.

24. A method of operating a network node of a new radio, NR, communications network during a random access, RA, procedure associated with a communication device, the method comprising:
determining information associated with at least one of the communication device and a channel between the communication device and the network node;
determining a number of physical RA channel, PRACH, transmissions to receive from the communication device as part of the RA procedure based on the information, wherein the PRACH transmissions are associated with the same Synchronization Signal Block, SSB; and
monitoring the NR communications network for the number of PRACH transmissions from the communication device as part of the RA procedure,
wherein the number of PRACH transmissions comprises at least two PRACH transmissions that are each associated with different transmission powers.

25-27. (canceled)

28. The method of claim 24, further comprising:
responsive to monitoring the NR communications network, determining a PRACH transmission has not been received during a predetermined period of time; and
responsive to determining the PRACH transmission has not been received during the predetermined period of time, monitoring the NR communications network for a number of PRACH retransmissions based on a network configured parameter.

29. The method of claim 24, further comprising:
transmitting (2410) an indication of PRACH transmission configuration information from the network node via a system information block, SIB, the PRACH transmission configuration information enabling the communication device to transmit multiple PRACH transmissions.

30. The method of claim 24, wherein monitoring the NR communications network for the number of PRACH transmissions comprises at least one of:
monitoring the NR communications network for a plurality of different preambles across a plurality of RA channel occasions, ROs, associated with a synchronization signal block associated with a portion of the PRACH transmissions; and
monitoring the NR communications network for the at least two PRACH transmissions in an order based on a path loss associated with each of the at least two PRACH transmissions.

31. The method of claim 24, wherein the number of PRACH transmissions comprises at least two PRACH transmissions that are each associated with different uplink, UL, transmission, Tx, beams, and
wherein monitoring the NR communications network for the number of PRACH transmissions comprises monitoring the NR communications network for the at least two PRACH transmissions via the different UL Tx beams.

32. (canceled)

33. The method of claim 24, wherein the at least two PRACH transmissions are each associated with different timing advances, TAs, and
wherein monitoring the NR communications network comprises monitoring the NR communications network the at least two PRACH transmissions using the different TAs.

34. (canceled)

35. A communication device, the communication device comprising:
processing circuitry; and
memory coupled to the processing circuitry and having instructions stored therein that are executable by the processing circuitry to cause the communication device to perform operations comprising:
determining information associated with at least one of the communication device and a channel between the communication device and the network node;
determining a number of physical RA channel, PRACH, transmissions to transmit to the network node prior to receiving a random access response as part of the RA procedure based on the information, wherein the PRACH transmissions are associated with the same Synchronization Signal Block, SSB; and
transmitting the number of PRACH transmissions to the network node as part of the RA procedure,
wherein the number of PRACH transmissions comprises at least two PRACH transmissions that are each associated with different transmission powers.

36. (canceled)
